(19) United States
(12) Patent Application Publication
(10) Pub. No.: US 2024/0248063 A1
(43) Pub. Date: Jul. 25, 2024

(54) SIGNAL MODULATION FOR ENCODING INFORMATION IN MULTIPLE DIMENSIONS

(71) Applicants: WASHINGTON STATE UNIVERSITY, Pullman, WA (US); TEXAS A&M UNIVERSITY, College Station, TX (US)

(72) Inventors: Brian H. CLOWERS, Pullman, WA (US); Elvin CABRERA, Kennewick, WA (US); David RUSSELL, Chappell Hill, TX (US); Arthur LAGANOWSKY, College Station, TX (US)

(21) Appl. No.: 18/422,476

(22) Filed: Jan. 25, 2024

Related U.S. Application Data
(60) Provisional application No. 63/481,530, filed on Jan. 25, 2023.

(51) Int. Cl. G01N 27/623; H01J 49/00

(52) U.S. Cl. CPC G01N 27/623; H01J 49/0036

(57) ABSTRACT

Examples include multidimensional detecting of properties of particles, including a first measuring device measuring a property of particles, in a first domain, outputting the particles with a sequence stepped second domain modulation corresponds to first domain measurement values. The sequence steps have a step interval extending in the first domain and changing from step to step according to a trajectory. For sequence steps having a preceding step, the step's second domain modulation state differs from the preceding step. A second measuring device decodes the particles' respective first domain measurements by demodulating the sequence stepped second domain modulation, and measures a second property of the particles, over a measuring interval in the first domain from an interval start point to an interval end point. The interval start point and the interval end point are synchronized to the step start and to the step stop.

### CROSS-REFERENCE TO RELATED APPLICATIONS

This application claims priority to the US provisional application filed on Jan. 25, 2023 and having U.S. Ser. No. 63/481,530, and the complete contents thereof is herein incorporated by reference.

### STATEMENT REGARDING FEDERALLY SUPPORTED RESEARCH OR DEVELOPMENT

This invention was made with government support under Grant/Contract Numbers R01 GM138863, awarded by the National Institutes of Health. The government has certain rights in the invention.

### TECHNICAL FIELD

This generally relates to measuring physical, chemical, and mechanical properties and, more particularly, to multiple stage measuring and corresponding data acquisition of gas-phase particles, such as ions, molecules, and others.

### BACKGROUND

When coupling two or more stages of on-line or off-line analysis the second stage of analysis is ideally much faster than the first to adequately sample information transmitted between dimensions. In situations where the second dimension of analysis is slower than the first modulation of information (e.g., electrical signals, molecules, ions, or particles) in the first dimension is necessary to effectively encode the first dimension information in the second or higher dimensions. A salient example of this approach is the frequency encoding of information from an ion mobility spectrometry (IMS) system coupled with an ion trap mass spectrometer. In the first report of this approach in 2016, the time-dependent information in the IMS domain is encoded in the mass spectrum (i.e., m/z domain) by modulating the frequency at which ions are allowed to enter and exit the IMS system. This approach encodes the mobility information in the intensity of the signal in the second domain. Transforming the signal from the second domain using a variety of frequency to time conversion approaches can yield the information from the first dimension with a high degree of fidelity.

Preceding public disclosure by Morrison and Clowers in 2016, description in U.S. Pat. No. 7,560,688 B2 and U.S. Pat. No. 10,132,777,B2, detail methods of performing ion mobility analysis with ion trap mass analyzers and a generalized method for performing Fourier transform-ion mobility (FT-IMS) analysis using mass spectrometry as a secondary detector. Additionally, U.S. Pat. No. 10,684,255 B2 recites concepts germane to FT-IMS processing but no enabling disclosure of information was provided in the application that would allow one skilled in the art the ability to reduce the invention to practice was provided. The disclosures presented in this invention remain new and impactful due to their capacity to simultaneously increase the speed of analysis and resolution for disparate dimensions of separation that occur on disparate or even the same timescales. Most importantly, the standard Fourier transform approach as previously disclosed requires linear modulation of the signal, modules, ions, or particles; whereas the present approach highlights a non-linear mode of modulation can be tailored to specific analyte or sets of analytes.

### SUMMARY

Features of the various embodiments include, but are not limited to, enhancing the speed of data acquisition. According to one or more embodiments, a data analysis system includes a coupling and a synchronization of two or more dimensions. An example according to one or more embodiments includes a direct coupling of gas-phase ion mobility separation devices with mass analyzers (e.g., ion trap mass analyzers) that collect spectra at acquisition rates that are within and order of magnitude or slower of the gas-phase mobility separation device. Another embodiment includes chemical separation domains including gas, liquid, and electrophoretic chromatography coupled with detectors that operate with acquisition rates that are slower than the first separation domain.

Another embodiment also includes the modulation of particulates, either charged or not, coupled with detectors that operate with acquisition rates that are slower than the first separation domain. For configurations where the second or higher order analysis domains are slower than the first, the signal from each preceding dimension must be modulated to achieve effective encoding of the relevant information in the subsequent analysis and measurement domains.

Encoding of information (e.g., m/z ratio, gas-phase ion mobility and its related properties, clustering behavior, and chemical transformations) between dimensions is achieved by synchronizing the delivery of signals or analytes delivered to the second of higher domains in a modulated fashion. Suitable examples of this behavior include frequency encoding information from the first dimension into the temporal data of the second or higher dimensions. Additionally, multiple levels of frequency encoding are also possible.

Signal multiplexing using, for example, Hadamard, Fourier, pseudo-random, and almost perfect sequences are all suitable templates for modulating of the signal between domains.

Even though the signals arriving at the detector need not be explicitly in the digital domain, modulation of the signals, molecules, or particles between domains can occur using either analog or digital means.

According to one or more embodiments, modulation techniques can further comprise and encompass multi-level modulation sequences and need not only be restricted to binary signal, ion, molecule, or particle modulation. When using digital and multi-level modulation strategies explicit modulation of the duty cycle is also claimed.

Encoding of information can be achieved by direct alteration or modulation of the signal but can also be achieved using temperature, pressure, voltage, density, or collision frequency to realize multidimensional separations between dimensions.

Synchronization between domains can be bidirectional, although the preferred embodiment is where subsequent domains dictate changes in modulation of information or molecules from the first dimension.

Linear signal modulation strategies are conventional. In contrast, various of the disclosed embodiments provide, among other features, a non-linear signal, molecule, ion, or particle modulation. The non-linear modulation techniques, in accordance with one or more embodiments, need not be continuous. In one or more embodiments, though, continuous non-linear modulation, for example, exponential, sigmoidal, quadratic, cubic and any function reasonably described by any n^{th}-order polynomial may be used. Benefits of modulation using a non-linear function include but are not limited to, minimizing redundant data acquisition points and minimizing time spent encoding of information between dimensions.

In accordance with various embodiments, non-linearity of signal, molecule, ion, or particle modulation can be implemented by, for example, by varying the rate of modulation in a manner directed to maximize the information gained for a specific set or sets of target analytes or signals. For example, features of one or more embodiments include, without limitation, a sawtooth sweep that among other further features includes utilization of the full length of the sawtooth frequency sweep. This, as also further described in later paragraphs, maximize the number of oscillations (i.e., periods) present in the transient.

Non-linear transitions between frequencies spanning multiple orders of magnitude may be features of the modulation vector. Frequency transitions spanning, for example, from 1 microHz to 1 GHz can be utilized to realize the desired outcome of increased experimental speed and targeted resolution enhancement.

Examples of ion mobility separation usable in practices according to various embodiments include, without limitation, modulation of ions from gas-phase ion mobility separation schemes include ions from stacked ring ion guides, planar structures, RF and DC confining electrode structures, and those that use non-linear fields to achieve effective confinement of ion populations exiting the first dimension into a secondary stage of analysis or separation.

An arrangement of one example method according to one or more can include embodiments provides a multidimensional detecting of properties of particles, and can include a measuring by a first measuring device of a first property of particles, the measuring producing measurement values in a first domain. The measuring steps of operations can include the first measuring device outputting the particles with a sequence stepped second domain modulation that corresponds to the particles' respective first domain measurement values. In accordance with various embodiments, the sequence steps can have a step interval extending in the first domain from a step start to a step stop, and can have a second domain modulating state that changes from step to step according to a first domain to second domain modulating state trajectory. In accordance with one or more embodiments, for each sequence step having a preceding step, the second domain modulation state of the preceding step differs from the second domain modulation state of said sequence step. The example method can further include a performing, by a second measuring device, of steps comprising: decoding of the particles' respective first domain measurement values by a demodulation of the sequence stepped second domain modulation, and measuring a second property of the particles, over a measuring interval extending in the first domain from a measuring interval start point to a measuring interval end point. In the example, in accordance with various embodiments, the measuring interval start point and the measuring interval end point can be synchronized to the step start and to the step stop.

This Summary identifies example features and aspects and is not an exclusive or exhaustive description of disclosed subject matter. Whether features or aspects are included in or omitted from this Summary is not intended as indicative of relative importance of such features or aspects. Additional features are described, explicitly and implicitly, as will be understood by persons of skill in the pertinent arts upon reading the following detailed description and viewing the drawings, which form a part thereof.

### BRIEF DESCRIPTION OF THE DRAWINGS

The following drawings form part of the present specification and are included to further demonstrate certain aspects of the present invention. The invention may be better understood by reference to one or more of these drawings in combination with the detailed description of specific embodiments presented herein.

FIG. 1 shows an example Linear Frequency Sweep;

FIG. 2 shows one example form of a stepped frequency sequence;

FIG. 3 shows one example form of a non-linear frequency sweep;

FIG. 4 shows an example raw data from a non-linear signal modulation;

FIG. 5 shows an example linearized data based on a non-linear data as shown in FIG. 4;

FIG. 6 shows an example raw Fourier transform of a data as shown in FIG. 5;

FIG. 7 shows examples of different polynomials that can be used as templates for modulation in accordance with one or more embodiments;

FIG. 8 shows examples of a selective sampling of a non-linear sweep according to one or more embodiments, to reduce the number of points for data acquisition while maintaining the same or approximate level of information content;

FIG. 9 demonstrates a density-based point selection technique according to one or more embodiments, which reduces the number of frequencies to modulation by a factor of 10 which subsequently decreases acquisition time while maintaining information content.

FIG. 10 show graphs of example forms of nonlinear sweeps in accordance with one or more embodiments, in particular, a saw tooth sweep in the left panel and a triangle sweep in the right panel.

FIG. 11 is a graph illustrating the comparative resolving power for linear and nonlinear sweeps for a 2000 point sweep.

FIG. 12 is a graph illustrating the comparative signal to noise ratio achieved for the same length experiments (e.g., 2000 point sweep) for linear and nonlinear sweeps.

FIG. 13 shows an experimental workflow for frequency modulated IM-MS. For all ions that fall within the monitored m/z range, transients (XICs) for any masses of interest may be extracted. In this example, transients shows an experimental workflow for frequency modulated IM-MS. For all ions that fall within the monitored m/z range, transients (XICs) for any masses of interest may be extracted. In this example, transients for mass ranges corresponding to T5A (m/z 298-301), T8A (m/z 466-469), and T10A (m/z 578-581) are shown. The following step is to Fourier transform the extracted transients to generate a frequency spectrum. The final step is to convert the frequency spectrum to an arrival time distribution by dividing the frequency values of the abscissa by the frequency sweep rate of the experiment.

FIG. 14 shows examples for compressed sensing signal reconstruction for six TXA salts using experimentally acquired 1000-point transients with in-silico sub-Nyquist subsampling, with subplot (a) showing a mass-selected T12A transient representing a target signal, subsamples of the target signal—“subsampled data”, and the transient that's been reconstructed using the subsamples, respectively, subplot (b) showing reconstructed arrival time distributions using traditional FT-IMS using 1000 points and CS-IMS using 100 points, and subplot (c) showing the mean squared error (MSE) of the target signal and the compressed sensing reconstruction for each TXA salt.

FIG. 15 shows plots showing transients and their corresponding arrival time distributions for TXA salts using FT-IM-MS and CS-IM-MS.

FIG. 16 shows reconstructed transients and arrival time distributions (ATDs) for singly-charged peptides [SDGRG+H]⁺ and [GRGDS+H]⁺, with upper row upper row (a) showing FT-IM-MS data collected using a 300-point sweep (left plot), resulting ATDs for individual analytes (center plot) and as a mixture (right plot); bottom row (b) showing CS-IM-MS data collected using a 150-point transient, with a left plot showing the raw 150 points and the resulting reconstructed 300-point transient superimposed. a center plot showing ATDs for individual analytes, and a right plot showing a mixture;

FIG. 17 shows reconstructed transients and ATDs for protonated amino acids [Leu+H]⁺ and [Ile+H]⁺, including having an upper row (a) showing, in a left plot, FT-IM-MS data collected using a 250-point sweep, a center plot and a left plot showing, respectively, ATDs for individual analytes and as a mixture; and a FIG. 17 bottom row (b) showing CS-IM-MS data collected using a 150-point transient. The raw 150 points were used to reconstruct the 250-point transient shown (left plot). ATDs generated from the reconstructed CS-IM-MS transient are shown for individual analyte solutions and as a mixture are also shown in the center and right plots, respectively.

FIG. 18 shows a schematic outline of a workflow for data handling in FT-IM-MS experiments and, more specifically, having a region (a) showing one example form of a starting mass spectrum; a region (b) shows example transients for ions of interest that are extracted (XICs) according to their m/z values; and a region (c) showing examples of m/z ranges generating respective transient (b).

FIG. 19 shows a graphic comparison of region (a) linear modulation and region (b) sawtooth modulation for mass selected transient for T8A (m/z 466-469). In this example, linear sweep experiments swept through 5-2005 Hz in 2000 scans, and sawtooth experiments swept through 2-2005 Hz in 400-scan increments. Both are examples of a full-frequency sweep conducted over the course of a single acquisition.

FIG. 20 shows graphs of example arrival time distributions for six TXA salts using, as shown in graph (a), linear sweeps and, as shown in graph (b), sawtooth sweeps. Linear sweep data was collected using a frequency range of 5-2005 Hz over 2000 scans. Sawtooth sweep data was collected using a frequency range of 5-2005 Hz over 400 scans and repeated five times for a total of 2000 points. Filled-in peak areas are Gaussian fits of the raw reconstructed data shown in grey;

FIG. 21 shows graphs of transients and reconstructed arrival time distributions for TXAs generated from a single sawtooth sweep modulating at 5-2005 Hz over 400 MS scans at five repetitions, showing an increased resolving power as the number of transient points is increased from 400 to 2000, and showing that as the number of sawtooth segments is increased, the number of amplitude jumps between the segments also increases;

FIG. 22 shows transients (a-c) and reconstructed arrival time distributions (d-f) for TXAs generated from a single sawtooth sweep modulating at 5-2005 Hz over 400 MS scans at five repetitions.

FIG. 23 shows mass spectrum for (a) GroEL and (b) streptavidin and the reconstructed ATDs for multiple charge states in panes (b) and (c), respectively. ATD reconstruction for GroEL was limited to the 63-67+ charge states as all other charge states yielded signals of SNR far too low for both sweeping methods. ATDs for sawtooth sweeps (four 500-scan segments at 5-1755 Hz) are plotted on the positive axis, and peaks on the inverted axis are reconstructed ATDs from linear sweeps (5-7005 Hz).

FIG. 24 shows as the sequence of frequencies is iteratively changed, the recorded ion current will take the form of a triangle wave (i.e., the cross-correlation between the two square waves used for modulation), the frequency of which is directly proportional to the frequency sweep rate. The rate at which frequencies are swept determines the frequency at which S(v)min and S(v)max values are observed.

FIG. 25 shows experimental reduced mobility (K0) values for T5-T12A collected at different frequency sweep rates compared to literature K0 (red dotted line

FIG. 26 shows normalized peak intensity for T7A plotted against reduced mobility (K0) at differing frequency sweep rates (a-e). Adjacent plots (f-j) are both the simulated and experimental frequency-modulated ion current from which the arrival time distributions were reconstructed (truncated to 300 Hz to show detail). As shown in subplots a-c/f-h the sweep rates are low enough to accurately capture the oscillations of the ion current. In contrast, subplots d-e/i-j show experiments where frequency spacing is too high to accurately capture oscillations and therefore induce signal aliasing. Aliased peaks are shown in red. As the sweep rate is further increased, the error becomes greater. The vertical line spanning plots a-e correspond to the unaliased experimental K0 value for the target analyte. Plot annotations include experimental K0, scan length, and sweep rate

FIG. 27 shows resolving power comparison between continuous linear and stepped frequency experiments at 2000 scans for tetraalkylammonium salts, T4A, T8A, T12A, and leu-enk singly charged monomer. With highest resolving power values achieved at higher terminal frequencies, both methods show similar performance across all sweep parameters. Each bar value is an average of five replicates and error bars show standard deviation.

FIG. 28 shows resolving power measured for different combinations of sweep lengths and terminal frequencies for cocaine, T8A, leu-enk dimer (leu-enk #1), and leu-enk monomer (leu-enk #2). Across all sweep lengths, the highest resolving power values are achieved at higher terminal frequencies. Each point is an average of five replicates with error bars showing standard deviation.

FIG. 29 shows signal to noise ratio (SNR) comparison for cocaine, T8A, leu-enk homodimer (leu-enk #1), and leu-enk monomer (leu-enk #2). SNR measured at differing combinations of terminal frequencies and scan lengths. Longer scans produce higher signal to noise ratio values at each terminal frequency used. Each point is an average of five replicates and error bars show standard deviation.

FIG. 30 shows, in the left column, interpolated frequency modulated signals for morphine, including, in left column subplot (a) 500 scans and, in left column subplot (b) 1000 scans and plotted up to the first 5 and 10 seconds, respectively, showing detail in the aligned oscillating signal; shows in its center column the linear averages of these signals; and shows in its right column their Fourier transform.

### DETAILED DESCRIPTION

The following are definitions of terms that may be used in the present specification. The initial definition provided for a group or term herein applies to that group or term throughout the present specification individually or as part of another group, unless otherwise indicated. It will be understood that any list of such candidates or alternatives is merely illustrative, not limiting, except where explicitly stated otherwise and in instances where a person of ordinary skill in the pertinent arts, reading the list in its context and in further view of the disclosure would, with reasonable certainty, understand otherwise.

As used in this specification and the appended claims, the singular forms “a,” “an” and “the” include plural referents unless the content clearly dictates otherwise.

The use of the word “a” or “an” when used in conjunction with the term “comprising” in the claims and/or the specification may mean “one,” but it is also consistent with the meaning of “one or more,” “at least one.” and “one or more than one.”

Throughout this application, the term “about” is used to indicate that a value includes the standard deviation of error for the device or method being employed to determine the value.

The use of the term “or” in the claims is used to mean “and/or” unless explicitly indicated to refer to alternatives only or the alternatives are mutually exclusive, although the disclosure supports a definition that refers to only alternatives and “and/or.”

As used in this specification and claim(s), the words “comprising” (and any form of comprising, such as “comprise” and “comprises”). “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps.

Unless otherwise indicated, numbers expressing quantities of ingredients, constituents, reaction conditions and so forth used in the specification and claims are to be understood as being modified by the term “about.” Accordingly, unless indicated to the contrary, the numerical parameters set forth in the specification and attached claims are approximations that may vary depending upon the desired properties sought to be obtained by the subject matter presented herein. At the very least, and not as an attempt to limit the application of the doctrine of equivalents to the scope of the claims, each numerical parameter should at least be construed in light of the number of reported significant digits and by applying ordinary rounding techniques. Notwithstanding numerical ranges and parameters setting forth the broad scope of the subject matter presented herein being approximations, the numerical values set forth in the specific examples are reported as precisely as possible. Any numerical values, however, inherently contain certain errors necessarily resulting from the standard deviation found in their respective testing measurements.

Features of one or more embodiments include the first stage of separation or analysis not needing to be faster than the second stage. Further, in accordance with one or more embodiments, by encoding the first domain information coming from the first stage in a separate domain (e.g., the frequency domain) the second stage separation or analysis dimension is free to proceed unhindered. As outlined by Morrison et al. for the specific case of ion mobility-mass spectrometry measurement the first domain of separation is often much slower (i.e., approximately 1 order of magnitude slower) than the second analysis domain. For example, if the first dimension temporally or spatially distributes signals, molecules, or particles such that the process requires 100 ms or more to complete, the second dimension of analysis or separation must operate approximately 10× faster to adequately sample the information from the first domain. A common scenario where such a configuration exists is in the coupling of drift-tube ion mobility spectrometry (IMS) experiments with time of flight mass spectrometers (TOF-MS). Here the IMS dimension separates ions on the ms time scale, whereas the TOF-MS records single spectra on the microsecond time scale.

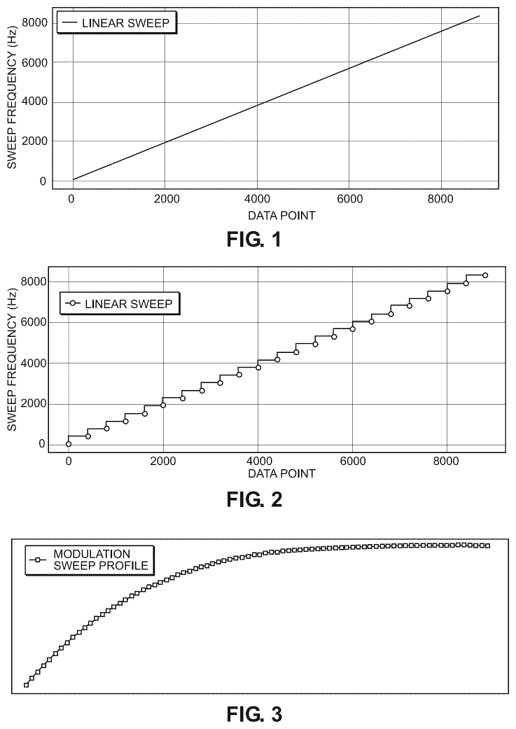

This “nested” paradigm breaks down, however, when an IMS is coupled with a slower secondary stage such as an ion trap, Fourier transform-Ion Cyclotron Resonance Mass Spectrometry (FT-ICR), or Orbitrap mass analyzer where the second dimension of analysis often occurs on the same time scale as the IMS experiment or even longer. To rectify this temporal or duty cycle mismatch the ion mobility information, historically measured in the time domain, can be encoded in the frequency domain. In these experiments the start of the frequency sweep (either with an increasing or decreasing slope) must be synchronized with the start of the ion trapping experiment and the stop point of the frequency modulation only need be noted but not explicitly synchronized with the termination of the linear frequency sweep. To be clear, 3D ion traps, linear ion traps, segmented ion traps, FT-ICR system, and the Orbitrap platform are collectively designated as ion trap mass analyzers. One facet of these systems is that the generation of each mass spectrum is preceded by an ion accumulation that can vary widely in the time domain (e.g., 1 ms to multiple seconds or longer). Additional modes of ion manipulation prior to mass analysis of the trapped ions include ion isolation, activation, fragmentation, and even additional ion trapping events. An issue here is that an extended duration is needed to isolate and scan out the ions. In fact, in many commercial embodiments of ion traps the timing between mass scans is not always constant. It may vary slightly from scan to scan. It is for this reason that synchronizing the start of the linear frequency sweep was originally pursued as shown in FIG. 1.

Alternatively, FIG. 2 shows a stepped frequency approach that has the same nominal slope (Hz/data point) as the sweep shown in FIG. 1. It will be understood that in practices according to various embodiments, the x-axis is not limited being a time axis and could be any other suitable domain, e.g., but not limited to frequency. For clarity, thinking of each data point as linearly increasing with time may help understand the subsequent descriptions. FIG. 2 shows a stepped frequency where each step change is frequency is synchronized directly with the desired event associated with the second dimension of analysis (e.g., ion trapping, activation, or scan out functions). One or more benefits, both direct and secondary are provided by the frequency of signal modulation remaining constant for each data point. In contrast, when using frequency sweep time as shown in FIG. 1, there is an ambiguity created data collection in the second dimension because, during the collection, the frequency of signal modulation is changing.

Referring to FIG. 2, although the frequency of signal modulation changes over the entire span of the second dimension data collection, the data collected in each data point in the second dimension originates from a single frequency.

Encoding of information, in practices according to one or more embodiments, from the first dimension can comprise, in combination with other features, a direct synchronization of the first dimension measuring and second dimension measuring. However, as will be understood from reading this disclosure in its entirety, the rate of synchronization is not limited to being linear. On the contrary, as described in more detail in later sections, synchronization can include a first measurement stage outputting first dimension measurements encoded, e.g., as modulation, in a second-dimension information. This can include, for example and without limitation, non-linear changes of a second-dimension modulation, sequences of pseudo-random step changes of frequency. Further, in systems and methods according to various embodiments, plots of a rate of second dimension encoding e.g., signal modulation against the first-dimension progression of an experiment can show multiple inflection points.

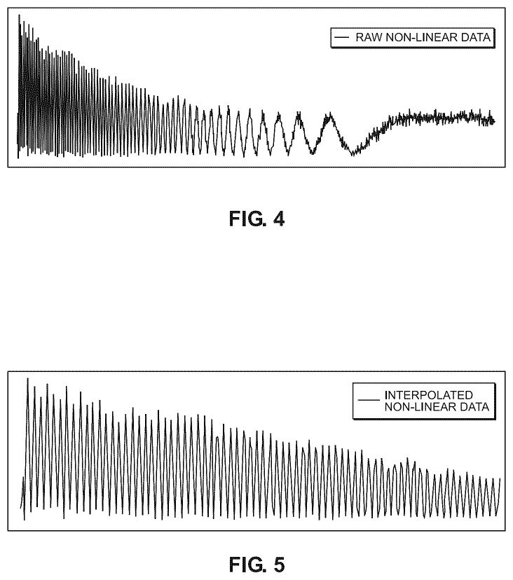

FIG. 3 shows an example, non-linear frequency sweep used to modulate the information in the first dimension while maintaining the synchronization of data acquisition in the second or higher order data acquisition system with changes in preceding stages of separation and analysis.

In the specific case of the Fourier-Transform Ion Mobility Spectrometry experiment (FT-IMS) the drift time of the target ion population (which is related to its mobility) is obtained by performing the Fourier transform of the raw time domain data which yields information in the frequency domain (Hz). Interestingly, because the signal was modulated using a user-defined sweep assumed to be linear, the drift time of any given ion population traversing the apparatus is determined by dividing this frequency by the sweep rate in (Hz/s). Dividing Hz by Hz/s yields the target data in seconds which is the desired parameter of interest.

In the present disclosure, we have outlined a general strategy for producing non-linear frequency sweeps, synchronizing signal modulation from these frequency sweeps with downstream separation and analysis domains, and reconstruction of the target waveform to allow direct transformation using Fourier (its associated variants), Gabor, Hilbert, and Hadamard Transforms. Periodic signal deconvolution approaches such as the Lomb-Scargle transformation and template based matching techniques including least squares and sparse reconstruction approaches are also possible to ultimately obtain the desired outcome.

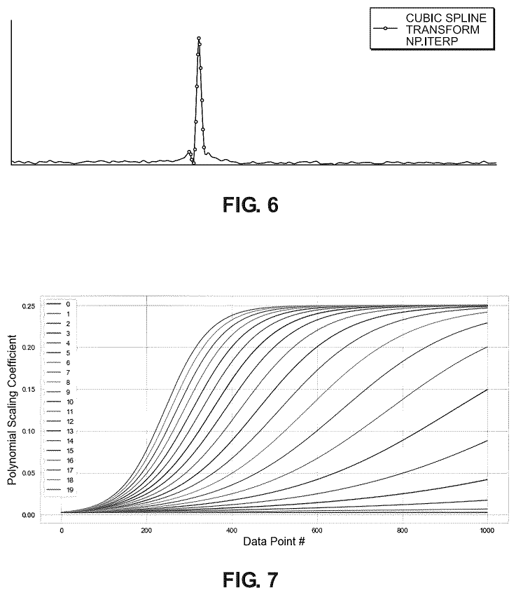

As demonstration of this approach, the sweep shown in FIG. 3 can produce a raw signal similar to the trace shown in FIG. 4. Using knowledge of the applied, non-linear frequency sweep it is possible to linearize the dataset to produce the spectrum shown in FIG. 5. In this step or even in the preceding step, it is possible to transform the data between the frequency and desired domain of modulation. In this specific case, transformation of the data in FIG. 5 produces the spectrum shown in FIG. 6. The target peak here corresponds to the ion population of interest and translation of the data point into the physical quantity of interest is a low complexity mathematical exercise. As will be understood by persons of ordinary skill in the pertinent arts, after reading this disclosure, the small shoulder peaks shown in FIG. 6 correspond to phase offsets that exist between the first and second dimensions of analysis.

It has been long known in the pertinent art that there may be promise in hybrid LC-IMS-MS of enhancing depth of coverage for a variety of analytical campaigns. However technical shortcomings have thus far presented obstructions. One example is that various preceding efforts to couple ion mobility experiments with mass spectrometers have a need to include upstream separations such as liquid or gas chromatography. Unfortunately, the speed of the IM platform when coupled with ion trap mass analyzers or those mass analyzers that require considerable time for analysis (even some TOF systems) is that high resolution IM separations and high-resolution MS measurements create sampling paradigms that are in conflict. Specifically, if both the IM and MS domains are sampled in the ms domain, one cannot be nested into the other. It is for this reason that the frequency or alternative domain encoding remains important. Currently, the existing IM-MS techniques using the Fourier transform approach with ion traps still often require >100 data points in the time domain to obtain even a modest resolving power in the IMS domain. To obtain high resolution IM spectra the raw data is extended for 10s and even 100s of seconds. To make this technique tractable for LC-IMS-MS coupling, increased sampling rates in the MS or downstream domain are needed or using the non-linear modulation scheme described it is possible to selectively sample the frequencies used for modulation. Using a data driven approach or even a random approach to sampling the frequencies for modulation it is possible to greatly decrease the number of data points needed to obtain the data shown in FIG. 4-6.

FIG. 7 highlights just one modulation technique including a modified sigmoidal curve that can be adjusted depending upon the type of experiment desired. Cubic, quadratic, and n^{th} order polynomials are all valid templates for modulation. The key aspect here is that the waveform is tailored to a specific type of experiment. Additionally, using data driven (e.g., density-based sampling) techniques to sample the sweep function can create frequency sweeps that contain greatly reduced numbers of data points which further reduces the time needed to collect a full mobility spectrum even if the system is encoding the drift time information in a separate domain (e.g., frequency). Using a priori or data dependent data acquisition strategies a different modulation waveform can be applied or changed during the course of experimentation.

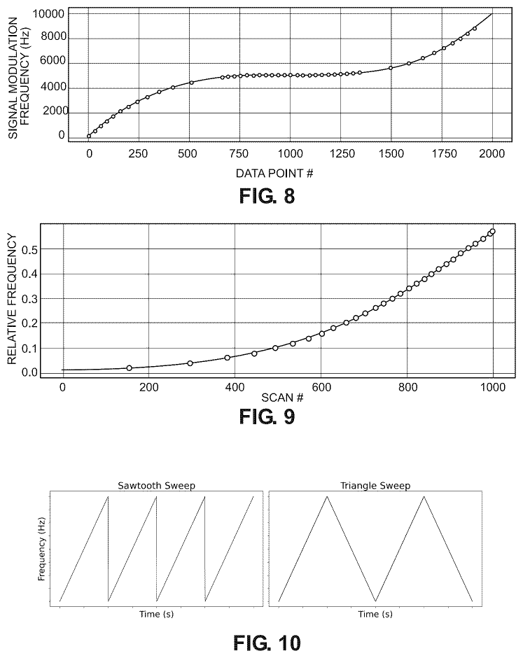

FIGS. 8 and 9 show different strategies for creating a subsample of the non-linear frequency sweep to minimize data acquisition time and maintain information content. This sampling of the frequency sweep need not be linear. Random, pseudo-random, and tailored sampling methods from the non-linear frequency sweep template are all valid techniques.

Tailored, Non-linear Signal Modulation for Encoding Information in Multiple Dimensions While the above is focused on mechanisms to enhance the speed of data acquisition for gas-phase ions, the general procedure and strategy can be used for any multidimensional data acquisition technique where the respective domains of measurement must be synchronized. Aspects in the disclosed embodiments include, without limitation, there being no need for the first dimension of separation or analysis to be faster than the second stage of analysis. In fact, by encoding the information coming from the first domain in a separate domain (e.g., the frequency domain) the second separation or analysis dimension is free to proceed unhindered. As outlined by Morrison et al. for the specific case of ion mobility-mass spectrometry measurement the first domain of separation is often much slower (i.e., >that 1 order of magnitude slower) than the second analysis domain. For example if the first dimension temporally or spatially distributes signals or molecules such that the process requires 100 ms to complete, the second dimension of analysis or separation must operate at least 10× faster to adequately sample the information from the first domain. A common scenario where such a configuration exists is in the coupling of drift-tube ion mobility spectrometry (IMS) experiments with time of flight mass spectrometers (TOF-MS). Here the IMS dimension separates ions on the ms time scale, whereas the TOF-MS records single spectra on the microsecond time scale. This “nested” paradigm breaks down when an IMS is coupled with a slower secondary stage such as an ion trap, Fourier transform-Ion Cyclotron Resonance Mass Spectrometry (FT-ICR), or Orbitrap mass analyzer where the second dimension of analysis often occurs on the same time scale as the IMS experiment or even longer. To rectify this temporal or duty cycle mismatch the ion mobility information, historically measured in the time domain, can be encoded in the frequency domain. In these experiments the start of the frequency sweep (either with an increasing or decreasing slope) must be synchronized with the start of the ion trapping experiment and the stop point of the frequency modulation only need be noted but not explicitly synchronized with the termination of the linear frequency sweep. To be clear, 3D ion traps, linear ion traps, segmented ion traps, FT-ICR system, and the Orbitrap platform are collectively designated as ion trap mass analyzers. A substantive feature of these systems is that the generation of each mass spectrum is preceded by an ion accumulation that can vary widely in the time domain (e.g., 1 ms to multiple seconds). Additional modes of ion manipulation prior to mass analysis of the trapped ions includes ion isolation, activation, fragmentation, and even additional ion trapping events. The key feature here is that an extended duration is needed to isolate and scan out the ions. In fact, in many commercial embodiments of ion traps the timing between mass scans is not always constant. It may vary slightly from scan to scan. It is for this reason that synchronizing the start of the linear frequency sweep was originally pursued.

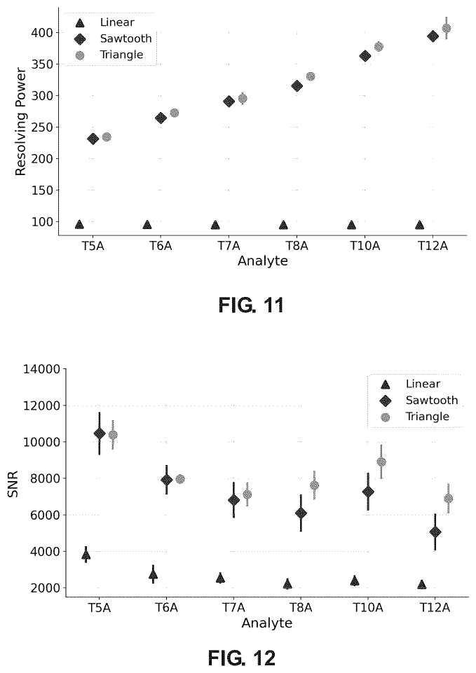

Embodiments employ nonlinear sweeps, such as sawtooth sweeps and triangle sweeps as depicted in FIG. 10, as opposed to linear sweeps. Benefits of nonlinear sweeps include, without limitation, focusing on regions with high quality oscillations. Further benefits using nonlinear sweeps according to disclosed embodiments include, without limitation, capability of meeting desired performance criteria while keeping the same sweep rates and point density. With reference to FIG. 11, it is notable that with 2000 point sweeps linear sweeps achieve a resolving power of approximately 100, while nonlinear sweeps achieve a resolving power of greater than 400. Furthermore, FIG. 12 shows that nonlinear sweeps, for 2000 point sweeps, achieved a higher signal to noise ratio (SNR) (>2×) for the same length experiments. Nonlinear sweeps were also found to have a higher resolving power than averages of SNR for linear sweeps.

It should be emphasized that the above-described embodiments and the following specific example implementations, arrangement, configurations, and modifications thereof particularly, any “preferred” embodiments, are merely examples of implementations, set forth to further assist the reader in obtaining a clear understanding of principles, features. Many variations, alternative arrangements, combinations and various sub-combinations, and other modifications may be made to the above-described embodiment(s) without departing substantially from the spirit and principles of the invention. All such variations, alternative arrangements, combinations and various sub-combinations, and other modifications are intended to be included herein within the scope of this disclosure and the present invention and protected by the following claims.

### Example 1

### Compressed Sensing Ion Mobility Mass Spectrometry

In this Example 1, it is demonstrated that there are significant increases in experimental speed for drift tube ion mobility-ion trap mass spectrometry (IM-MS) using compressed sensing methods. By encoding all gas-phase ion mobility information in the m/z domain, Fourier transform ion mobility approaches have facilitated the decrease in acquisition time using ion trap mass analyzers to single minutes. Central to Fourier transform IM-MS (FT-IM-MS) is the mass-extracted ion transient in which the drift period through an apparatus is encoded as a frequency. Due to conventional signal processing considerations, a minimum number of measurements may be needed to more accurately capture all frequency content of the transient. This can place logical constraints on the speed of FT-IM-MS experimental speed. Herein, the text below reports notable increases in experimental speed through compressed sensing ion mobility mass spectrometry (CS-IM-MS). Superseding the need to collect a large number of measurements, transients are accurately reconstructed from a reduced number of points through compressed sensing reconstruction strategies.

The performance of CS-IM-MS was benchmarked using a suite of tetraalkylammonium salts, isobaric peptides SDGRG and GRGDS, the amino acids Ile and Leu, and bradykinin. The resolving power and resolution achieved closely matches that of traditional FT-IM-MS. Coupling an atmospheric pressure drift tube IMS to an Orbitrap MS, it is possible to increase the speed in of data acquisition.

### Introduction

Ion mobility spectrometry (IMS) is a gas-phase separation technique that measures characteristic mobilities for ionized species under the influence of a weak and uniform electric field and a counterflow of an inert drift gas (e.g., nitrogen).^{1,2} Under select circumstances the gas-phase ion mobility is measured directly from experimental observations, and through a series of simplifying assumptions, these mobilities can be used to deduce a orientationally-averaged ion-neutral collisional cross section (CCS).^{3,4} While arguments regarding the accuracy of absolute CCS values are beyond the scope of this report, CCS provides a foundation to make inferences about the structure and shape of the analyte of interest. Such information is of particular importance for structural characterization of biologically relevant molecules.⁵⁻⁸ Mass spectrometry (MS) is a technique that measures the mass-to-charge ratio (m/z) of an ionized species. However, MS is typically seen as a hyphenated technique due to conformational information being largely transparent in the mass domain. Naturally, interfacing IMS and MS systems (IM-MS) is commonly seen as the data yielded by both techniques are highly complementary.⁹

Interfacing IMS systems with ion trap mass spectrometers specifically is of particular interest due to their higher achievable resolution and, of course, their ability to trap ions and employ different fragmentation techniques.^{10,11} One of the primary difficulties when interfacing a drift tube IMS system with an ion trap is overcoming their mismatched duty cycles. IMS separations occur on the order of single to tens of milliseconds, whereas ion traps operate on the order of tens to hundreds of milliseconds, and due to the similar timescales, nesting the data from one domain into another becomes either a difficult or time-consuming endeavor. A commonly seen approach to circumvent the duty cycle mismatch is utilizing a second scanning gate at the terminal end of the IMS drift region that only opens according to a predefined time delay relative to the opening of the first gate. The time delay is such that it allows for ions of a single drift time to exit the IMS and enter the downstream mass spectrometer for detection. Once enough averages are recorded for a particular drift time, the gate delay is stepped to the next drift time, and this process is repeated many times which effectively slices the arrival time distribution (ATD) into multiple signal-averaged points. The resulting experimental timescales for this mode of collecting data is primarily dictated by the range of drift times recorded, amount of signal averaging, and how many scanning steps the second gate is subjected to.¹²⁻¹⁵ Factors which typically lead to experimental acquisitions that take hours.

A solution to overcoming duty cycle mismatches while also largely reducing experimental times for IM-MS came in the form of multiplexed IMS, in particular, through Fourier transform ion mobility mass spectrometry (FT-IM-MS).^{16,17} Not only are single minute experiments realized, but higher ion throughput, signal-to-noise ratios (SNR), and resolving powers are achieved relative to signal averaging approaches.¹⁷⁻²⁰ Similar to the second scanning gate methods, FT-IM-MS also requires two ion gates that enclose the drift region, albeit with a different gate modulation scheme. FT-IM-MS achieves continuous frequency filtering by exploiting the resonance between the drift time of an ion and the corresponding gate modulation frequency throughout the duration of a user-defined frequency sweep. The defining characteristic of FT-IM-MS is that the mobility information is encoded in an ion transient. This transient is Fourier transformed to generate a frequency spectrum that is converted into an ATD by dividing the abscissa values (Hz) by the frequency sweep rate (Hz/s).

In general, the frequency sweep takes the form of a simple linear function (e.g., 5-8005 Hz) where both ion gates simultaneously modulate at each of the frequencies contained in the sweep. The properties of the frequency sweep (e.g., frequency range, sweep rate, etc.) are central to the FT-IM-MS experiment as they determine key metrics such as the length of the experiment, the achievable resolution, SNR, and most importantly the range of drift times that are accurately captured.^{17,21-24} In order to accurately reconstruct arrival time distributions for all ions within a specified drift time range, the sweeps must be constructed in accordance with the limitations imposed by the Shannon-Nyquist sampling theorem; a theorem that applies to all signals that contain frequency information. In the context of FT-IM-MS it means that there is a minimum number of data points that must be collected for faithful recovery of all frequencies present within the resulting transient.^{25,26} Therefore, this places an upper bound on the speed at which the experiment is carried out. Although conventional FT-IM-MS experiments typically occur on the order of single minutes, this is still far too slow to accommodate front-end separations such as liquid chromatography.

Herein we report our solution to drastically increase the experimental speed of IM-MS, compressed sensing ion mobility mass spectrometry (CS-IM-MS). In contrast to FT-IM-MS, instead of collecting a full ion transient via a typical frequency sweep, compressed sensing allows a full ion transient to instead be reconstructed by collecting only a small fraction of the points often required by Shannon-Nyquist sampling. Through a combination of applying the fundamentals of frequency modulation of IMS and the ideas of compressed sensing we achieved experimental timescales not possible with conventional signal processing techniques.

### Theory

In traditional signal processing routines, one of the main considerations when discretely measuring a signal is the sampling frequency in relation to the frequency content of the signal being measured. A strict lower bound for the minimum sampling frequency (or equivalently, number of points) is defined by the Shannon-Nyquist sampling theory. The theory states that for any given signal where the maximum frequency component is fₘₐₓ, one must maintain a minimum sampling frequency of 2fₘₐₓ in order to accurately record the signal.^{25,26} Not meeting the minimum sampling threshold will result in a phenomenon called signal “aliasing” where the components that are at higher frequencies than the sampling frequency will appear at incorrect frequencies (i.e., frequency aliases). Readers are directed to the recently published work describing these limitations in the context of FT-IM-MS experiments.²³

In general, the convention was to measure discrete signals in accordance with the Shannon-Nyquist sampling theorem. In the last twenty years advances in signal processing theory have allowed for sub-Nyquist sampling rates; advances that were inspired by the ideas of data compression. Generally, data compression is achieved by first collecting a full dataset that abides by the Shannon-Nyquist sampling theorem. Once collection is complete, all but the essential information required for reconstruction is discarded. As one may imagine, this is a highly inefficient process, as time is wasted collecting data that will eventually be thrown out. A question asked in the seminal works by Candes, Romberg, Tao, and Donoho is whether it is possible to instead collect a fraction of the measurements required by the Shannon-Nyquist sampling theorem (i.e., undersample a signal) and still be able to faithfully reconstruct a signal. Extraordinarily, it was proven to be possible to reconstruct highly undersampled signals given the signal of interest and measurement matrices have certain required properties.^{27,28} The signal must be compressible (i.e., sparse), a low-coherence measurement matrix must be used, and have a sufficient number of points.

One of the first requirements that must be addressed is the requirement of sparsity. For a given universal basis-Fourier basis matrix, in our case—the signal must have a compressible representation within that basis, that is, it must be K-sparse within the Fourier basis. Where K is the number of Fourier coefficients. Interestingly, and most important for the present set of experiments, frequency modulated IM-MS naturally satisfies this requirement through the encoding of the mobility information in the m/z domain. Stated differently, for a given m/z range, only a handful of frequency (i.e., mobility) components will be present. Knowing this, we can leverage sparsity to readily apply compressed sensing techniques to these experiments. To further develop these concepts it is useful to consider the following linear equation:

$$y = C Ψs = Θ s \qquad Equation ( 1 )$$

Where y is the measurement values, C is the measurement matrix indicating when or where measurements were taken, Ψ is the universal basis matrix (e.g., Fourier basis matrix), and s is the sparse representation of the signal. In general, y, C, and Ψ are known and the goal is to solve for s. However, this is not a simple operation. The dimensions of the measurement matrix, C, are p×n where p is the number of measurements and n is the number of unknowns. In the case of highly undersampled signals, p<<n; the system is considered underdetermined, and an infinite set of solutions are possible for such a system. Assuming the true solution contains only K frequency components (i.e., K-sparse) and K<p<<n, the l₀-pseudonorm may converge to the true solution:

$$min {‖ s ‖}_{0} subject to : y = {Θ}_{s} \qquad Equation ( 2 )$$

However, solving this is a combinatorially hard problem and computationally expensive due to the brute-force nature of solving this problem. Furthermore, there's no guarantee that a particular calculated solution is indeed the most optimal solution, such a problem would be considered to be nonconvex.^{29,30} However, given certain requirements are met, the optimal l₀-pseudonorm solution can be closely approximated by l₁ minimization (i.e., convex relaxation):³¹

$$min {‖ s ‖}_{1} subject to : y = Θ s \qquad Equation ( 3 )$$

If the signal contains noise, we can add a denoising term, ¿:

$$min {‖ s ‖}_{1} subject to : {‖ y - Θ s ‖}_{2} < ε \qquad Equation ( 4 )$$

However, relaxing to an l₁ minimization problem does not come without cost; certain requirements must be met. First as mentioned above, the signal must be K-sparse in the chosen universal basis. Additionally, the measurement matrix and the universal basis must also have low coherence, in other words, there should be no correlation between the pattern in which measurements are taken and the components of the universal basis matrix. Randomized measurement matrices have been shown to have low coherence with any fixed universal basis and therefore why we have opted to use randomized frequency sweeps.^{30,32,33} The last requirement is collecting enough measurements. Even though compressed sensing allows for sub-Nyquist sampling, there is still a practical lower limit in the number of measurements that must be taken. The lower bounds are defined by the following:^{30,33}

$$p = mK log ( n / K ) \qquad Equation ( 5 )$$

where
p is the number of points (measurements),
m is a constant multiplier, K is the sparsity level, and
n is the number of unknowns.

Donoho and Tanner have shown that when a sufficient number of measurements are taken, the answer will converge to the optimal solution with exceedingly high probability.³⁴ An advantage to using the sparsity-promoting l₁-norm minimization is that it is able to set Fourier components to zero. In contrast, l₂-norm minimization (i.e., least squares) never fully sets components to zero and thus frequency components may be recovered that may not actually be present in the true signal. This is due to the harsher (squared) penalization of the l₂-norm when minimizing the euclidean distance between the measurements and estimated signal.³⁰ The effects of least squares solutions can be seen in earlier spectral estimation work.³⁵ Another benefit of operating through an l₁ minimization for spectral reconstruction is that it does not require any a priori knowledge of ambiguous regularization parameters or training data. It is due to these advantages that compressed sensing has been applied to other fields such as medical imaging.^{36,37}

### Experimental

### Chemicals and Reagents

All chemicals were purchased from Sigma-Aldrich. Tetraalkylammonium (TXA) salts tetrapentylammonium bromide (T5A), tetrahexylammonium bromide (T6A), tetraheptylammonium bromide (T7A), tetraoctylammonium bromide (T8A), tetrakisdecylammonium bromide (T10A), and tetradodecylammonium bromide (T12A) were diluted to concentration of 1 micro mole (μM) in methanol with 0.1% formic acid. Amino acids isoleucine (Ile) and leucine (Leu), reverse sequence pentapeptides SDGRG (Ser-Asp-Gly-Arg-Gly) and GRGDS (Gly-Arg-Gly-Asp-Ser), and bradykinin were diluted to final concentrations of 50 μM in 80:20 methanol:water mixture with 0.1% formic acid.

### Instrumentation

All analytes were ionized using nanoelectrospray (nESI) using borosilicate glass capillaries pulled in-house. nESI voltage was applied via a silver wire inserted into the capillary at a +300-1000 V bias relative to the first electrode of the desolvation region of the IMS. Drift tube ion mobility experiments were carried out at ambient conditions (˜690 Torr, 20-25° C.) using a dual-gate ion mobility spectrometer (IMS). The IMS consists of a 10 cm desolvation region followed by a 20 cm drift region with a set of tri-grid ion gates at the entrance and exit of the drift region.³⁸ Operating voltage gradient for the IMS was at 470 V cm-1 and applied via gold-coated (ENIG) copper electrodes printed on flexible polyimide sheets.³⁹ The electrode sheets were rolled and inserted into custom 3D printed cases and soldered to PCB containing resistor chains, each of which were printed and designed in-house.⁴⁰ A 5.5 L min-1 flow of high-purity nitrogen gas was supplied at the terminal end of the IMS. A high nitrogen flow rate was required due to the ˜5 L min⁻¹ conductance of the mass spectrometer. The terminal end of the IMS was interfaced to the inlet of an Q Exactive HF-X Orbitrap mass spectrometer (Thermo Fisher Scientific, San Jose, CA). The resolution of the mass spectrometer was set to 30,000 and a fixed injection time set to 70 ms which results in an average of 81 ms between scans. IMS frequency sweeps and MS scans were synchronized using Arduino-based microcontrollers connected to open-source ion gate pulsers previously described.⁴¹ Synchronization is required for precise control of each of the modulation frequencies in the experimental sequence.

### Data Processing

All data processing and frequency sweep creation was accomplished using custom Python scripts. Conventional linear sweeps (for FT-IM-MS) were generated using a simple linear function where only the frequency range and number of points were specified. Compressed sensing sweeps were generated in a similar manner, albeit with an extra step. After generating a full-length linear sweep (e.g., 1000 points), values in the sweep were randomly subsampled at a reduced number of points (e.g., 100 points), leaving a compressed version of the original frequency sweep. Different random number generator seeds were used for the different frequency sweeps used in this work. It will be understood that although compressed sensing experiments operate at sub-Nyquist timescales, the original sweep that is originally sampled from must still sample above the Nyquist limit. This can have significant effect on success in reconstructing the full-length transients. We refer the reader to our previous work detailing how to generate frequency sweeps of appropriate lengths.²³

Generated “.RAW” files were converted to the “.mzML” format using the “msConvertGUI” tool from ProteoWizard.⁴² For each replicate, ion chromatogram data (transient) was extracted for the mass range (monoisotopic peak and isotopic envelope) corresponding to the analyte of interest. Processing the transient differed depending on whether the experiment was FT-IM-MS or CS-IM-MS. Transient processing for FT-mode involved zero-padding and signal detrending (i.e., center at x-axis) prior to Fourier transform. Processing the undersampled CS-mode transients also first required detrending prior to reconstruction to a full transient. Reconstruction was accomplished using the linear program solver in the CVXPY package.^{43,44} The solver objective was set to minimize the l₁ norm of the estimated signal (see Equation 4), and the constraint was set to keep the l₂ norm of the difference between the estimated signal and the normalized raw data under a specified noise value, ε (see Equation 4, right). Noise values were empirically determined to be in the range of 1.0-2.0. It is worth noting that reconstruction was robust and successful reconstruction was still achieved even with small variations in the noise values. After reconstruction of the transient, processing proceeded as normal, the transient was zero-padded and subsequently Fourier transformed. The resulting frequency domain spectrum resulting from the FT was converted to an arrival time distribution by dividing the abscissa (Hz) by the frequency sweep rate (Hz/s) that results in units of time (s). Single-peak resolving power (Rₚ=t_{d}/Δt_{d}) and two-peak resolution (R=1.18 (t_{d,b}−t_{d,a})/(fwhmₐ+fwhm_{b})) were calculated according to gaussian peak fits. Throughout this manuscript, reference to the number of “points” will be analogous to number of “mass scans” or “MS scans” in the context of signal (i.e., transient) length. Due to the synchronized nature of modulation frequencies and mass spectrometer scans, each point in the transient is a product of a single mass scan and corresponds to a single value in the frequency sweep.²²

### Results and Discussion

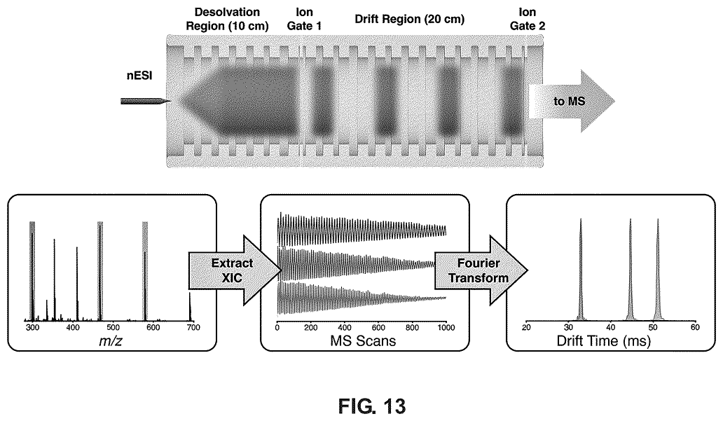

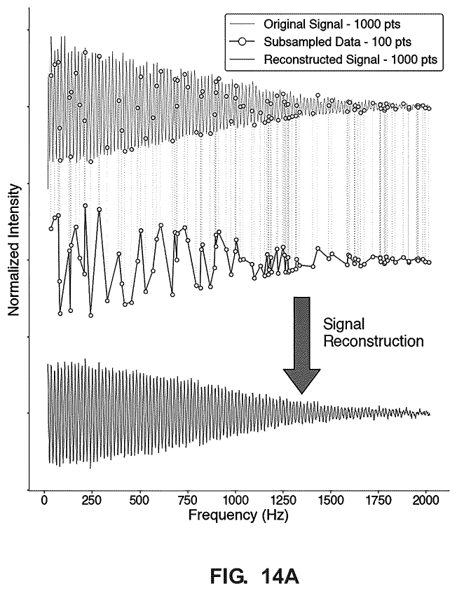

First, we briefly describe a manner of encoding mobility domain information into the mass domain via frequency modulation of ion gates; an approach utilized by both CS-IM-MS and FT-IM-MS. We refer to FIG. 13, which shows an experimental workflow for frequency modulated IM-MS. For all ions that fall within the monitored m/z range, transients (XICs) for any masses of interest may be extracted. In this example, transients shows an experimental workflow for frequency modulated IM-MS. In accordance with one or more embodiments, for all ions that fall within the monitored m/z range transients (XICs) for any masses of interest may be extracted. In the FIG. 13 example, transients for mass ranges corresponding to T5A (m/z. 298-301), T8A (m/z. 466-469), and T10A (m/z 578-581) are shown. The following step was to Fourier transform the extracted transients to generate a frequency spectrum. A final step was to convert the frequency spectrum to an arrival time distribution by dividing the frequency values of the abscissa by the frequency sweep rate of the experiment.

As can be seen in FIG. 13, feature of frequency modulation is the two ion gates that enclose the drift region of the IMS, one for ion admission at the start of the drift region and another for filtering at the terminal end. As both ion gates simultaneously modulate according to any of the frequencies in the sweep, ions are continuously admitted into the drift region by the first gate. As ions traverse the drift region, only those with drift times resonant with the modulation frequency arrive at the second gate while it is open. This resonance is simply a function of the between drift times, modulation frequency, and modulation frequency harmonics. As the modulation frequency changes at the beginning of each new mass scan, the population of ions that are in resonance with gate modulation also changes. Ions that make it past the second gate can enter the mass spectrometer for detection, and thus, each recorded mass scan has already been mobility-filtered and the abundance of each m/z value will change depending on the current position within the frequency sweep. This is the mechanism that allows for a mass-selected transient to be extracted for all ions monitored by the mass spectrometer within a single experimental acquisition. This encoding is what results in the short experiment times seen historically for FT-IM-MS. As previously stated, the speed of FT-IM-MS is ultimately limited by the Shannon-Nyquist sampling theorem and thus makes sweeping frequencies the most time-consuming aspect of the experiment. In contrast to this, CS-IM-MS employs the same data encoding strategy albeit at faster sub-Nyquist rates that are facilitated by the ability to reconstruct full transients using drastically undersampled ion signals.

### Determination of Constant, m

To assist in guiding subsequent experimental efforts, an initial evaluation of theoretical performance was conducted through in-silico subsampling of transients collected via a conventional FT-IM-MS experiment. The goal was to provide a value for m by solving Equation 5 when p, K, and n are known. Doing so allows for an approximate lower bound for the number of points, p, required for reconstructing an unknown signal. Mass-selected transients for six TXA salts (T5A-T8A, T10A, T12A) were chosen as model analytes due to their high-SNR transients.

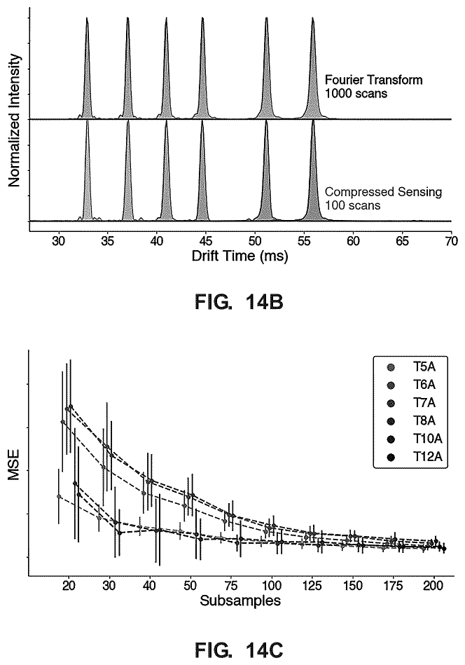

From the 1000-point transient generated for each analyte in FT-IM-MS mode (FIG. 2a, top), multiple replicates of randomized subsamples were taken (multiple randomizer seeds were used for each replicate). Subsample lengths (p) ranged from 200 to just 20 points. It is worth noting that all lengths chosen for subsampling were at sub-Nyquist lengths for this set of analytes; the lower bound for conventional FT-IM-MS processing of these analytes is ˜250 points. A representative example of a 100-point subsampled transient is shown in FIG. 14 center subplot for T12A. Vertical red dotted lines connecting the original FT-IM-MS transient and the subsampled transient indicate where the subsamples were taken from. Using only the subsamples, the original 1000-point transient was reconstructed (FIG. 14 subplot a, bottom), effectively simulating the data processing that would occur in a CS-IM-MS experiment. An example of the resulting ATDs from the original and reconstructed signal is shown in FIG. 14 subplot b. For each replicate of subsampling, the original transient and the reconstructed transient were compared using mean-squared-error (MSE) values (FIG. 14 subplot c). Upon inspection of the MSE values in FIG. 14 subplot c, a reasonable tradeoff between minimizing the number of points and accurate reconstruction occurs somewhere between 75-100 points. Using this information, we can now calculate constant m from Equation 5, where the optimal number of measurements (p) is 100, the number of unknowns (n) is 1000, and the number of frequency components, i.e., sparsity level (K), is 1. These values were chosen to help ensure accurate reconstruction and thus why we have chosen to use a model transient that's been oversampled and a subsample size with a lower MSE. In general, the value for m dependent on the coherence between the sampling matrix and basis matrix (C and Y′ in Equation 1, respectively) and considering each sampling matrix we construct is based on the same random number generator, it is reasonable that this value will hold for subsequent experiments.³⁰

### Experimental Compressed Sensing Results

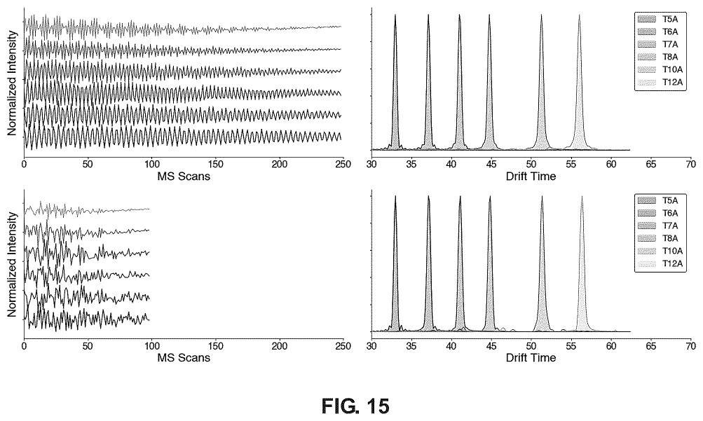

The arrival time distributions reconstructed from each of the respective transients is directly to the right. It is notable that the minimum required for FT mode is ˜250 points whereas CS requires only 100 points. An exemplary first evaluation of experimental CS-IM-MS signal reconstruction was for six TXA salts, T5A-T8A, T10A, and T12A; each of which generates single-frequency transients. The two plots on the left of FIG. 15 show raw transients from FT-IM-MS and CS-IM-MS experiments, respectively. The FT-IM-MS transients were products of a 250-point frequency sweep ranging from 20-2020 Hz. These sweep parameters chosen for FT-IM-MS were not arbitrary, 250 points was the minimum number of points required for successful recovery of the full span of frequencies, and by extension, the full range of drift times for this set of analytes (see plot in top right of FIG. 15). In contrast, it was possible to achieve the same results with a highly undersampled transient using compressed sensing. The CS-IM-MS frequency sweeps also ranged from 20-2020 Hz; however, this was done with only 100 randomly selected frequencies (see bottom left of FIG. 15). Using only these 100-point undersampled transients, the full 250-point transient was successfully reconstructed. Furthermore, the resulting ATD (see plot in bottom right of FIG. 15) was almost identical to the one constructed from FT-IM-MS. Using compressed sensing strategies, we have been able to reduce the experimental time required by 60% relative to conventional FT-IM-MS.

Further comparisons for the arrival time distributions from an FT-IM-MS experiment and CS-IM-MS experiments at various lengths. Although through compressed sensing one can conduct experiments at sub-Nyquist timescales, a minimum number of points can still be required for accuracy in reconstructing an ion transient. An arrival time distribution generated from an optimized FT-IM-MS sweep was used as a reference. Not only can erroneous frequencies be recovered, but the number of frequency components may also be incorrect. This suggests that the absolute minimum number of points in this experiment is somewhere between 50 and 100 points. Remarkably, even at 50 and 25 points, the ATDs are successfully reconstructed. This suggests that the probability of accurate reconstruction is based on each individual drift time.

Although single-frequency transients are commonplace when encoding mobility data into the mass domain, transients containing multiple frequencies must also be considered. A common instance of this is when multiple isobars or multiple conformations of a single ion are present. To probe these scenarios isomeric peptides, SDGRG and GRGDS, and amino acids Ile and Leu were used to assess isobaric reconstruction, each offering different levels of achievable separation. Doubly-protonated bradykinin was also used to assess reconstruction of a single compound with multiple conformers, one of which is not completely distinguishable from baseline noise.

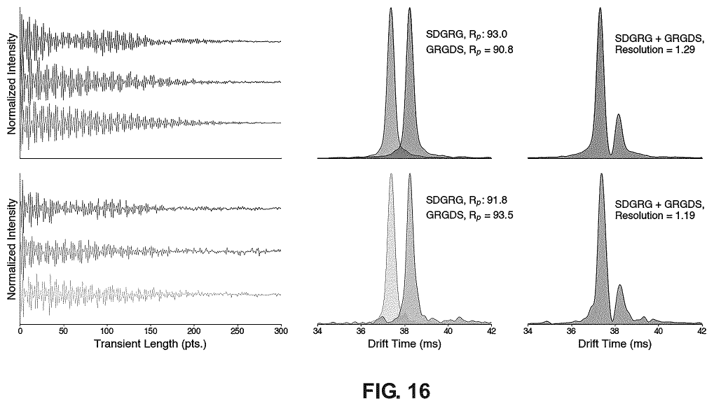

The singly-charged reverse sequence peptides [SDGRG+H]⁺ and [GRGDS+H]⁺ were first compared, both of which having an m/z 491. With FT-IM-MS, 300-point sweeps with a frequency range of 20-3520 Hz (FIG. 16) were employed. This length was the minimum number of points required for conventional signal processing. The corresponding ATDs for [SDGRG+H]⁺ and [GRGDS+H]⁺ as individual analytes and as a mixture are shown in FIG. 5a (center and right subplots, respectively). For the current set of experimental conditions, [SDGRG+H]⁺ had an average drift time 37.4 ms and [GRGDS+H]⁺ had an average drift time of 38.2 ms, a difference of 0.8 ms. Casting this in terms of transient frequencies, 37.4 ms equates to 5.37 Hz and 38.2 ms to 5.49 Hz, a difference of only 0.12 Hz. Additionally, close-to baseline resolution (R=1.29) between these peptides was achieved using FT-IM-MS. Using compressed sensing, we were able to recover all the same information in just half the time. CS-IM-MS data was collected using a 150-point sweep (a 12 second experiment). The raw 150 data points were used to reconstruct a full 300-point transient. The resulting ATDs were also successfully reconstructed for both the individual analytes and the mixture. The average recovered CS-IM-MS drift times were 37.4 ms for [SDGRG+H]⁺ and 38.3 ms for [GRGDS+H]⁺. Peak shapes were indistinguishable from FT-IM-MS with similar resolution (R=1.19) achieved. The slight difference in resolution is a result of the wider peak recovered for [GRGDS+H]⁺ in the mixture. Furthermore, the baseline is not as clean for the CS-IM-MS ATDs. This is likely due to the samples concentrated at frequencies where severe signal occurs and contributing to reconstruction error, however, this is a topic that we are currently still investigating. In addition to the comparison in FIG. 16, raw CS-IM-MS transients and arrival time distributions for [SDGRG+H]⁺ and [GRGDS+H]⁺ highlighted the reproducibility between replicates and the robustness of reconstruction. Reproducibility and precise control over modulation frequencies is due to the synchronization between each frequency in the sweep and each MS scan. Due to the randomized nature of generating frequency sweeps, it is important that reconstruction is consistent regardless of what randomized frequencies are chosen. Signal reconstruction across different randomizer seeds is consistent.

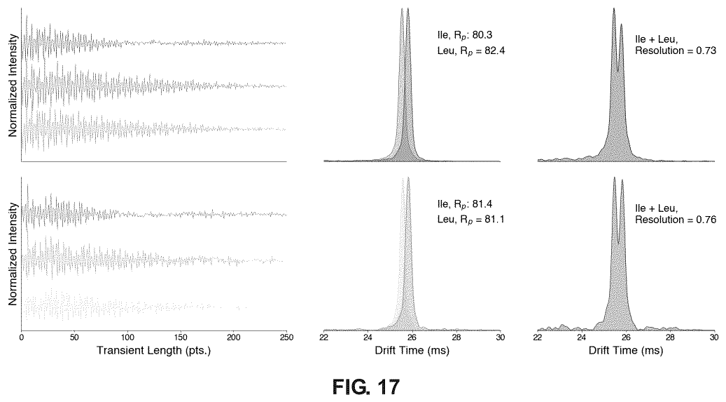

Compressed sensing reconstruction for a more challenging set of constitutional isomers, isoleucine [Ile+H]⁺ and leucine [Leu+H]⁺, was also evaluated. Reference FT-IM-MS experiments employed 250-point frequency sweep with a frequency range of 20-4020 Hz (FIG. 17). Reference ATDs resulted in average drift times of 25.5 ms for Ile and 25.8 ms for Leu, these drift times correspond to frequencies of 5.03 Hz and 5.09 Hz, respectively, a difference of just 0.06 Hz. CS-IM-MS data was collected using a 150-point sweep, over the same range of 20-4020 Hz. The raw 150-point transients used to reconstruct a full 250-point transient and subsequently reconstruct the arrival time distributions shown in FIG. 17. Despite such a small difference in the transient frequencies of each analyte, they were recovered using compressed sensing recovery which resulted in average drift times of 25.6 ms and 25.8 ms for Ile and Leu, respectively. Again, the recovered ATDs using FT-IM-MS and CS-IM-MS were indistinguishable. Through CS-IM-MS, the required experimental time for this set of analytes was reduced to 60% of the minimum required for conventional FT-IM-MS.

Both the reverse peptide and amino acid data yielded ATD peaks that were well-defined above the baseline noise. In contrast to this, we compared signal reconstruction for the bradykinin [BK+2H]²⁺ ion. Two conformations exist for this charge state of bradykinin, where the less abundant conformational state is not completely distinguishable from baseline noise. FT-IM-MS data was collected using a 180-point sweep ranging from 20-2520 Hz. Using this sweep, a resolution of 0.98 between each of the peaks was achieved. Due to the combination of transient decay at a low terminal frequency and fast drift time, the required number of points (180 points) for an FT-IM-MS sweep was already low. However, even in this case, through compressed sensing, we were still able to achieve a modest decrease in experimental time and reduce the required number of points by ˜22% while achieving a similar resolution of 1.04 (FIG. 7b). We remind the reader that the ATD results from a full FT-IM-MS sweep that is highly optimized, and the maximum recoverable drift time for this sweep is not far beyond the drift time of the analyte, 36 ms in this case. As the number of required points for FT-IM-MS increases, the efficiency of compressed sensing also increases. For example, if we wanted to increase the maximum drift time of the FT-IM-MS ATD to 60 ms, for example, we would need to increase the conventional sweep to ˜300 total points. Alternatively, with a compressed sweep would only need to increase to ˜150 total points. For reference, at an 81 ms mass spectroscopy scan time, the FT-IM-MS experiment would need to increase by 9.7 seconds, whereas the CS-IM-MS would only increase by 0.81 seconds.

### Example 1—Conclusions

Through the implementation of compressed sensing strategies, we have dramatically decreased the minimum required timescales required for ion mobility-ion trap MS well beyond the limits of Fourier-based strategies. In some cases, a 60% decrease in experiment time was achieved. In addition to speed increases, transients with frequency components differing in just 0.06 Hz were also accurately recovered. Although a basic basis-pursuit class algorithm was successfully used for compressed sensing recovery, further investigation is needed to determine the most appropriate algorithm for compressed sensing reconstruction. Different algorithms typically differ in the amount of a priori knowledge required for faithful spectral reconstruction (e.g., number of frequency components, noise levels, etc.). It is to be expected that this may vary based on the quality of the signal being recorded and, of course, the amount of information one has of the chemical system. The approach taken in this work is the simplest approach where a minimal amount of prior information is required, only an empirically determined noise value and the level of sparsity. Although some a priori knowledge about approximate signal sparsity should be known, it is an unambiguous metric that can be readily accounted for by simply modifying the number of points. Some required knowledge of the system is not unique to compressed sensing, as traditional signal processing methods require some knowledge of the frequency content of the signal for determining appropriate sampling frequencies. Furthermore, we acknowledge that the data shown in this work is derived from well-behaved chemical mixtures, that is, produce high-SNR transients with slow decay rates. Our current investigations are focused on extending the frameworks for CS-IM-MS to systems containing larger analytes, which typically contain low-SNR transients that rapidly decay. To this end, the work presented here is a first step in development of CS-IM-MS strategies and has resulted in large leaps in experimental speed. LC-compatible ion mobility-ion trap MS timescales are now imminent.

### Example 1—References

(1) Revercomb, H. E.; Mason, E. A. Theory of Plasma Chromatography Gaseous Electrophoresis.pdf. Anal. Chem. 1975, 47 (7), 970-983.
(2) Siems, W. F.; Wu, C.; Tarver, E. E.; Hill, H. H., Jr; Larsen, P. R.; McMinn, D. G. Measuring the Resolving Power of Ion Mobility Spectrometers. Anal. Chem. 1994, 66 (23), 4195-4201.
(3) Siems, W. F.; Viehland, L. A.; Hill, H. H., Jr. Improved Momentum-Transfer Theory for Ion Mobility. 1. Derivation of the Fundamental Equation. Anal. Chem. 2012, 84 (22), 9782-9791.
(4) Siems, W. F.; Viehland, L. A.; Hill, H. H. Correcting the Fundamental Ion Mobility Equation for Field Effects. Analyst 2016, 141 (23), 6396-6407.
(5) Zheng, X.; Aly, N. A.; Zhou, Y.; Dupuis, K. T.; Bilbao, A.; Paurus, V. L.; Orton, D. J.; Wilson, R.; Payne, S. H.; Smith, R. D.; Baker, E. S. A Structural Examination and Collision Cross Section Database for over 500 Metabolites and Xenobiotics Using Drift Tube Ion Mobility Spectrometry. Chem. Sci. 2017, 8 (11), 7724-7736.
(6) Picache, J. A.; Rose, B. S.; Balinski, A.; Leaptrot, K. L.; Sherrod, S. D.; May, J. C.; McLean, J. A. Collision Cross Section Compendium to Annotate and Predict Multi-Omic Compound Identities. Chem. Sci. 2019, 10 (4), 983-993.
(7) Poltash, M. L.; McCabe, J. W.; Shirzadeh, M.; Laganowsky, A.; Russell, D. H. Native IM-Orbitrap MS: Resolving What Was Hidden. Trends Analyt. Chem. 2020, 124. https://doi.org/10.1016/j.trac.2019.05.035.
(8) McCabe, J. W.; Shirzadeh, M.; Walker, T. E.; Lin, C.-W.; Jones, B. J.; Wysocki, V. H.; Barondeau, D. P.; Clemmer, D. E.; Laganowsky, A.; Russell, D. H. Variable-Temperature Electrospray Ionization for Temperature-Dependent Folding/Refolding Reactions of Proteins and Ligand Binding. Anal. Chem. 2021, 93 (18), 6924-6931.
(9) Christofi, E.; Barran, P. Ion Mobility Mass Spectrometry (IM-MS) for Structural Biology: Insights Gained by Measuring Mass, Charge, and Collision Cross Section. Chem. Rev. 2023, 123 (6), 2902-2949.
(10) Theisen, A.; Black, R.; Corinti, D.; Brown, J. M.; Bellina, B.; Barran, P. E. Initial Protein Unfolding Events in Ubiquitin, Cytochrome c and Myoglobin Are Revealed with the Use of 213 Nm UVPD Coupled to IM-MS. J. Am. Soc. Mass Spectrom. 2019, 30 (1), 24-33.
(11) Sipe, S. N.; Sanders, J. D.; Reinecke, T.; Clowers, B. H.; Brodbelt, J. S. Separation and Collision Cross Section Measurements of Protein Complexes Afforded by a Modular Drift Tube Coupled to an Orbitrap Mass Spectrometer. Anal. Chem. 2022, 94 (26), 9434-9441.
(12) Clowers, B. H.; Hill, H. H., Jr. Mass Analysis of Mobility-Selected Ion Populations Using Dual Gate, Ion Mobility, Quadrupole Ion Trap Mass Spectrometry. Anal. Chem. 2005, 77 (18), 5877-5885.
(13) Tang, X.; Bruce, J. E.; Hill, H. H., Jr. Design and Performance of an Atmospheric Pressure Ion Mobility Fourier Transform Ion Cyclotron Resonance Mass Spectrometer. Rapid Commun. Mass Spectrom. 2007, 21 (7), 1115-1122.
(14) Ibrahim, Y. M.; Garimella, S. V. B.; Prost, S. A.; Wojcik, R.; Norheim, R. V.; Baker, E. S.; Rusyn, I.; Smith, R. D. Development of an Ion Mobility Spectrometry-Orbitrap Mass Spectrometer Platform. Anal. Chem. 2016, 88 (24), 12152-12160.
(15) Keelor, J. D.; Zambrzycki, S.; Li, A.; Clowers, B. H.; Fernández, F. M. Atmospheric Pressure Drift Tube Ion Mobility-Orbitrap Mass Spectrometry: Initial Performance Characterization. Anal. Chem. 2017, 89 (21), 11301-11309.
(16) Knorr, F. J.; Eatherton, R. L.; Siems, W. F.; Hill, H. H., Jr. Fourier Transform Ion Mobility Spectrometry. Anal. Chem. 1985, 57 (2), 402-406.
(17) Morrison, K. A.; Siems, W. F.; Clowers, B. H. Augmenting Ion Trap Mass Spectrometers Using a Frequency Modulated Drift Tube Ion Mobility Spectrometer. Anal. Chem. 2016, 88 (6), 3121-3129.
(18) Poltash, M. L.; McCabe, J. W.; Shirzadeh, M.; Laganowsky, A.; Clowers, B. H.; Russell, D. H. Fourier Transform-Ion Mobility-Orbitrap Mass Spectrometer: A Next-Generation Instrument for Native Mass Spectrometry. Anal. Chem. 2018, 90 (17), 10472-10478.
(19) Kwantwi-Barima, P.; Reinecke, T.; Clowers, B. H. Increased Ion Throughput Using Tristate Ion-Gate Multiplexing. Analyst 2019, 144 (22), 6660-6670.
(20) Kwantwi-Barima, P.; Reinecke, T.; Clowers, B. H. Enabling Resolution of Isomeric Peptides Using Tri-State Ion Gating and Fourier-Transform Ion Mobility Spectrometry. Int. J. Ion Mobil. Spectrom. 2020, 23 (2), 133-142.
(21) Clowers, B. H.; Siems, W. F.; Yu, Z.; Davis, A. L. A Two-Phase Approach to Fourier Transform Ion Mobility Time-of-Flight Mass Spectrometry. Analyst 2015, 140 (20), 6862-6870.
(22) Cabrera, E. R.; Clowers, B. H. Synchronized Stepped Frequency Modulation for Multiplexed Ion Mobility Measurements. J. Am. Soc. Mass Spectrom. 2022, 33 (3), 557-564.
(23) Cabrera, E. R.; Clowers, B. H. Considerations for Generating Frequency Modulation Waveforms for Fourier Transform-Ion Mobility Experiments. J. Am. Soc. Mass Spectrom. 2022, 33 (10), 1858-1864.
(24) Butalewicz, J. P.; Sanders, J. D.; Clowers, B. H.; Brodbelt, J. S. Improving Ion Mobility Mass Spectrometry of Proteins through Tristate Gating and Optimization of Multiplexing Parameters. J. Am. Soc. Mass Spectrom. 2023, 34 (1), 101-108.
(25) Nyquist, H. Certain Topics in Telegraph Transmission Theory. Transactions of the American Institute of Electrical Engineers 1928, 47 (2), 617-644.
(26) Shannon, C. E. Communication in the Presence of Noise. Proceedings of the IRE 1949, 37 (1), 10-21.
(27) Candes, E. J.; Romberg, J.; Tao, T. Robust Uncertainty Principles: Exact Signal Reconstruction from Highly Incomplete Frequency Information. IEEE Trans. Inf. Theory 2006, 52 (2), 489-509.
(28) Donoho, D. L. Compressed Sensing. IEEE Trans. Inf. Theory 2006, 52 (4), 1289-1306.
(29) Candès, E. J.; Wakin, M. B.; Boyd, S. P. Enhancing Sparsity by Reweighted €1 Minimization. J. Fourier Anal. Appl. 2008, 14 (5), 877-905.
(30) Manohar, K.; Brunton, B. W.; Nathan Kutz, J.; Brunton, S. L. Data-Driven Sparse Sensor Placement for Reconstruction: Demonstrating the Benefits of Exploiting Known Patterns. IEEE Control Syst. Mag. 2018, 38 (3), 63-86.
(31) Tropp, J. A. Just Relax: Convex Programming Methods for Identifying Sparse Signals in Noise. IEEE Trans. Inf. Theory 2006, 52 (3), 1030-1051.
(32) Candes, E. J.; Tao, T. Near-Optimal Signal Recovery From Random Projections: Universal Encoding Strategies? IEEE Trans. Inf. Theory 2006, 52 (12), 5406-5425.
(33) Needell, D.; Tropp, J. A. CoSaMP: Iterative Signal Recovery from Incomplete and Inaccurate Samples. Appl. Comput. Harmon. Anal. 2009, 26 (3), 301-321.
(34) Donoho, D.; Tanner, J. Observed Universality of Phase Transitions in High-Dimensional Geometry, with Implications for Modern Data Analysis and Signal Processing. Philos. Trans. A Math. Phys. Eng. Sci. 2009, 367 (1906), 4273-4293.
(35) Davis, A. L.; Reinecke, T.; Morrison, K. A.; Clowers, B. H. Optimized Reconstruction Techniques for Multiplexed Dual-Gate Ion Mobility Mass Spectrometry Experiments. Anal. Chem. 2019, 91 (2), 1432-1440.
(36) Meneguitti Dias, F.; Khosravy, M.; Cabral, T. W.; Monteiro, H. L. M.; de Andrade Filho, L. M.; de Mello Honório, L.; Naji, R.; Duque, C. A. Chapter 9—Compressive Sensing of Electrocardiogram. In Compressive Sensing in Healthcare; Khosravy, M., Dey, N., Duque, C. A., Eds.; Academic Press, 2020; pp 165-184.
(37) Ashour, A. S.; Guo, Y.; Alaa, E. E.; Kasem, H. M. 9-Discrete Cosine Transform-based Compressive Sensing Recovery Strategies in Medical Imaging. In Advances in Computational Techniques for Biomedical Image Analysis; Koundal, D., Gupta, S., Eds.; Academic Press, 2020; pp 167-184.
(38) Langejuergen, J.; Allers, M.; Oermann, J.; Kirk, A.; Zimmermann, S. High Kinetic Energy Ion Mobility Spectrometer: Quantitative Analysis of Gas Mixtures with Ion Mobility Spectrometry. Anal. Chem. 2014, 86 (14), 7023-7032.
(39) Smith, B. L.; Boisdon, C.; Young, I. S.; Praneenararat, T.; Vilaivan, T.; Maher, S. Flexible Drift Tube for High Resolution Ion Mobility Spectrometry (Flex-DT-IMS). Anal. Chem. 2020, 92 (13), 9104-9112.
(40) Naylor, C. N.; Cabrera, E. R.; Clowers, B. H. A Comparison of the Performance of Modular Standalone Do-It-Yourself Ion Mobility Spectrometry Systems. J. Am. Soc. Mass Spectrom. 2023, 34 (4), 586-594.
(41) Garcia, L.; Saba, C.; Manocchio, G.; Anderson, G. A.; Davis, E.; Clowers, B. H. An Open Source Ion Gate Pulser for Ion Mobility Spectrometry. Int. J. Ion Mobil. Spectrom. 2017, 20 (3), 87-93.
(42) Chambers, M. C.; Maclean, B.; Burke, R.; Amodei, D.; Ruderman, D. L.; Neumann, S.; Gatto, L.; Fischer, B.; Pratt, B.; Egertson, J.; Hoff, K.; Kessner, D.; Tasman, N.; Shulman, N.; Frewen, B.; Baker, T. A.; Brusniak, M.-Y.; Paulse, C.; Creasy, D.; Flashner, L.; Kani, K.; Moulding, C.; Seymour, S. L.; Nuwaysir, L. M.; Lefebvre, B.; Kuhlmann, F.; Roark, J.; Rainer, P.; Detlev, S.; Hemenway, T.; Huhmer, A.; Langridge, J.; Connolly, B.; Chadick, T.; Holly, K.; Eckels, J.; Deutsch, E. W.; Moritz, R. L.; Katz, J. E.; Agus, D. B.; MacCoss, M.; Tabb, D. L.; Mallick, P. A Cross-Platform Toolkit for Mass Spectrometry and Proteomics. Nat. Biotechnol. 2012, 30 (10), 918-920.
(43) Diamond, S.; Boyd, S. CVXPY: A Python-Embedded Modeling Language for Convex Optimization. J. Mach. Learn. Res. 2016, 17.
(44) Agrawal, A.; Verschueren, R.; Diamond, S.; Boyd, S. A Rewriting System for Convex Optimization Problems. Journal of Control and Decision 2018, 5 (1), 42-60.

### Example 2

### Nonlinear Frequency Modulation for Fourier Transform Ion Mobility Mass Spectrometry Improves Experimental Efficiency

### Introduction

Through optimization of terminal frequencies and effective sampling rates, we have developed nonlinear sawtooth-shaped frequency sweeps for efficient Fourier transform ion mobility mass spectrometry (FT-IM-MS) experiments. This contrasts with conventional FT-IM-MS experiments where ion gates are modulated according to a linear frequency sweep. Linear frequency sweeps are effective but can be hindered by the amount of useful signal obtained using a single sweep over a large frequency range imposed by ion gating inefficiencies, particularly small ion packets, and gate depletion. These negative factors are direct consequences of the inherently low gate pulse widths of high-frequency ion gating events, placing an upper bound on FT-IM-MS performance. Here, we report alternative ion modulation strategies. Sawtooth frequency sweeps may be constructed for the purpose of either extending high-SNR transients or conducting efficient signal-averaging experiments for low-SNR transients. The data obtained using this approach show high-SNR signals for a set of low-mass tetraalkylammonium salts (<1000 m/z) where resolving powers above 500 are achieved. Data for low-SNR obtained for multimeric protein complexes streptavidin (53 kDa) and GroEL (800 kDa) also reveal large increases in the signal-to-noise ratio for reconstructed arrival time distributions.

Fourier transform ion mobility spectrometry (FT-IMS) is a time-effective method for interfacing drift tube ion mobility spectrometry with orbitrap and ion trap mass spectrometers (FT-IM-MS). 1-5 This contrasts with early IM-MS work that employed other methods such as the second scanning gate method in order to interface both instruments. Despite the success of this approach, it comes with a steep cost in experimental timescales. The second scanning gate method utilizes two ion gates that enclose the drift region, the first gate is used for ion injection and the second is used for filtering ions based on their drift time. Filtering is achieved through the opening of the second gate that aligns with a specific drift time, i.e., through a time delay relative to the opening of the first gate. Ions that make it through the second gate are admitted to the mass spectrometer at the terminal end of the IMS. One may choose to continuously sample one drift time by keeping a static time delay or scan a range of drift times by stepping the time delay across a wide range.6-8 The primary factors that determine the overall acquisition time are the range of drift times that are being sampled, how fine the time delay is stepped, and the amount of signal averaging required. Given this set of parameters, one can see why high-bandwidth signals are highly penalized; long acquisition times are seen when measuring a wide range of drift times, and it is not uncommon to see experimental campaigns that take hours.3,6 FT-IM-MS is not limited by these factors, the arrival time distributions and mass spectra of all ions are measured simultaneously within a single acquisition that will typically take single minutes.

Fourier-based multiplexing is generally achieved through the modulation of two ion gates, one at the entrance and another at the exit of the IMS drift region. Both ion gates are synchronically modulated according to a user-generated frequency sweep rate, typically starting at a few Hz, and linearly sweeping the frequencies up to a terminal frequency within the single kHz (e.g., 5-8005 Hz). As a discrete packet of ions is released into the drift region by the first ion gate, the time it takes for each ion to traverse the drift region is determined by its characteristic mobility under the given set of experimental conditions (e.g., electric field strength, temperature, etc.) 9. However, even though all ions will be admitted into the drift region, not all will arrive at the second ion gate during an opening event. The alignment of the ion's arrival at the second gate and the open state of the gate is completely determined by the ion's drift time. For example, an ion with a 1 ms drift time will only arrive at the second gate while it is open if the gates are currently being modulated at 1 KHz (and its harmonics). Furthermore, because ions are resonant with more than one of the modulation frequencies, the resulting frequency-modulated signals for each ion oscillate similarly to a damped sinusoid, generally referred to as the ion transient. This transient is then Fourier transformed to give a frequency that is directly related to an ion's drift time. Recovering these drift times can require only dividing frequencies (Hz) by the rate the ion gates sweep frequencies (Hz/s). 10,11

One of the main limitations in the performance of FT-IMS is the severe signal attenuation that arises at low gate pulse widths (GPW) for high modulation frequencies. For example, gates being modulated at 8000 Hz with a 50% duty cycle result in an effective GPW of 62.5 microseconds (μs). Such short GPWs necessarily result in the injection of smaller ion packets and thus result in a decreased amplitude when ions arrive at the detector. The gate depletion effect also contributes to attenuation due to its discriminatory effect against low-mobility ions during gating events. 12,13 The combined effects of both injection of small ion packets and gate depletion limits the magnitude of the changing ion flux seen by the detector. This results in an upper limit for the terminal frequency used for gate modulation where well-defined oscillations can be observed. Efforts to mitigate the effects of low GPWs through tristate ion gating have been shown to increase the overall ion current, thereby reducing signal attenuation; however, this approach requires additional hardware to execute the pulsing sequences. 13-16 Here, we describe an easy-to-implement alternative using existing FT-IM-MS hardware. Sawtooth modulation is achieved through the consecutive repetition of a short frequency sweep that covers a limited range of frequencies. To avoid unnecessary increases in experimental timescales that far exceed what the Shannon-Nyquist sampling theorem requires, a prerequisite for generating efficient nonlinear sawtooth sweeps is the minimization of terminal frequencies and effective sampling rates. This nonlinear modulation approach can be tailored for signal processing for either high signal-to-noise ratio transients or low signal-to-noise ratio transients. For each case, we show increases in resolving power and signal-to-noise ratio (SNR) using a suite of tetraalkylammonium salts and large multimeric protein complexes such as streptavidin and GroEL, respectively.

### Materials and Methods

### Chemicals and Reagents

Tetraalkylammonium (TXA) salts (Sigma-Aldrich, St. Louis, MO) tetrapentylammonium (T5A), tetrahexylammonium (T6A), tetraheptylammonium (T7A), tetraoctylammonium (T8A), tetrakisdecylammonium (T10A), and tetradodecylammonium (T12A) were diluted to 1 μM in 80:20 methanol:water and 0.1% formic acid.

Streptavidin and GroEL solutions were buffer exchanged into 200 mM ammonium acetate using Micro Bio-spin P-6 Gel Columns (Bio-Rad, Hercules CA) and diluted to working concentrations of 1-5 μM.

### Instrumentation

Atmospheric pressure mobility separations were conducted at ambient conditions (690-700 Torr and 20-25° C.) using a dual-gate ion mobility spectrometer consisting of a 10 cm desolvation region and a 20 cm drift region. IMS voltage gradient (481 V/cm) was applied using gold-coated (ENIG) copper electrodes printed on a polyimide (Kapton) substrate, as described by Smith et al. and were enclosed within a PLA casing and electronics printed and designed in-house.17,18 Tri-grid shutter design was used for both sets of gates and modulated by open-source pulsers as previously described. 19,20 Ions were introduced into the drift tube via electrospray at the first electrode of the desolvation region at a bias of +0.3-2 kV relative to the first electrode using pulled-borosilicate glass capillaries. The terminal end of the drift region is interfaced to the inlet of an Orbitrap Q Exactive HF-X mass spectrometer (Thermo Fisher Scientific, San Jose, CA) for post-mobility separation mass analysis. The terminal end of the IMS also includes an inlet for the introduction of a counterflow of dry nitrogen drift gas at 5.5 L min-1. Such a high flow rate is required due to the ˜5 L min-1 conductance of the mass spectrometer inlet.

Reduced pressure ion mobility experiments were conducted using a 1.5 m periodic focusing drift tube interfaced with the HCD cell of an Orbitrap Q-Exactive UHMR mass spectrometer (Thermo Fisher Scientific, Bremen, Germany).4,21,22 Ions enter a heated capillary into an RF ion funnel (526 kHz, 200 Vp-p) directly into the 1.5 m periodic focusing drift tube, maintained with approximately 1.5 Torr helium. Following the drift tube, the ions travel to the HCD cell through a 4.5 mm r0 octopole (1.7 MHz, 200 Vp-p). All DC and RF voltages were generated by a Modular Intelligent Power Supply (MIPS) System (GAA Custom Engineering, Kennewick, WA). Ions were generated by nanoelectrospray ionization. Borosilicate glass capillaries (Sutter Instruments, Navajo, CA) with 10 cm length, 1.5 mm outer diameter, 0.86 mm inner diameter were pulled to a 1-5 μM tip using a P100 tip puller (Sutter Instruments). Instrument diagrams can be found in Supporting Information FIGS. S1 and S2.

### Gate Modulation and Data Processing

IMS ion gates were modulated according to the synchronized frequency-MS scan mode described previously.23 Briefly, TTL triggers from the mass spectrometer generated at each new mass scan were monitored by an Arduino-based microcontroller that advances to the next modulation frequency at each new scan event (in accordance with a user-defined frequency sweep). A subtle modification to the pulsing profiles loaded on the microcontroller provides the mechanism to output the sawtooth waveforms.21 The generated “.RAW” files were converted to “.mzML” files using “up” from the ProteoWizard package.24 Using custom Python scripts, each ion transient (also referred to as XIC, time-domain signal, or frequency-modulated signal) was extracted for the m/z range that corresponded to each ion's isotopic envelope. These transients were then subsequently Fourier transformed to generate a frequency domain spectrum. The frequency domain axis (Hz) of this spectrum was then divided by the effective sweep rate (Hz/s) at which the gates were modulated to reconstruct the arrival time distribution.

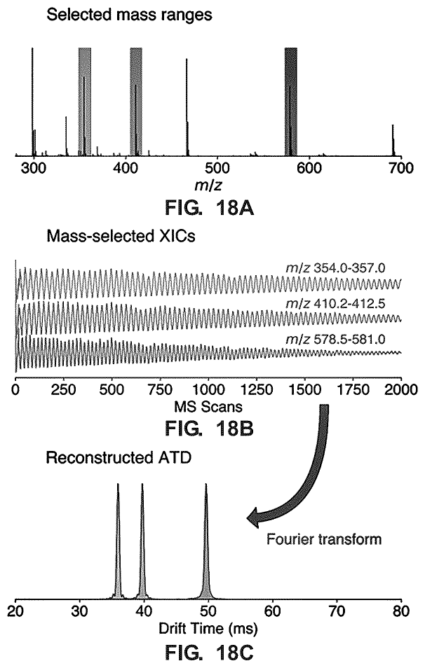

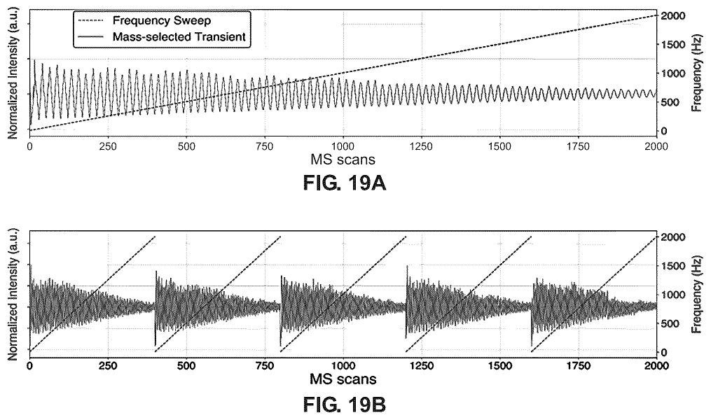

FIG. 18 shows a representative schematic outlining, with subplots (a), (b), and (c), a workflow for data handling in FT-IM-MS experiments using systems and method in accordance with various embodiments. Further detailed information on scripts used for data processing can be found in our previous work.25 Referring to FIG. 18, starting with the mass spectrum as show in the figure's subplot (a), transients for each ion of interest are extracted (XICs) according to their m/z values and, as seen in subplot (b), each m/z range will generate its own transient (b). The ion transients are subsequently Fourier-transformed to generate a frequency spectrum. The recovered frequencies (Hz) are then divided by the frequency sweep rate (Hz/s) to convert the abscissa values to time (s) units which then leaves the final reconstructed arrival time distributions shown in subplot (c).

As discussed below, two main approaches are taken for processing the nonlinear data. For the single ion monitoring approach, an ion's full transient was treated as a simple damped sinusoid with phase discontinuities at each restart point in the sawtooth sweep. For a Fourier transform with minimal processing artifacts, only the first segment of the signal was Fourier transformed for the estimate of the signal's frequency. This frequency was then used to create a bandpass filter to apply to each segment of the signal. The phase for each segment was then determined and truncated at phase values such that the ends of the segment matched the phase of all other segment ends. Following this, all filtered segments were concatenated which produced a phase-continuous signal for final processing (example code in Supporting Information). The signal-averaging approach was straightforward and simple. The full sawtooth signal was evenly split at each point of the transient that corresponded to each restart in the sawtooth sweep. Each of these segments was then ensemble averaged to generate the (reduced-point) final signal used for the Fourier transform and eventual reconstruction of the arrival time distribution. In both cases, effective sampling frequency was minimized so as to reach equivalent experimental lengths as the linear sweep counterparts. Details for sampling rate minimization can be found in previous work. 11,16

### Results and Discussion

FIG. 19 subplot (a) and subplot (b) show, respectively, comparison of linear modulation and sawtooth modulation for mass selected transient for tetraoctylammonium (T8A) (m/z 466-469). In this example, linear sweep experiments swept through 5-2005 Hz in 2000 scans, and sawtooth experiments swept through 2-2005 Hz in 400-scan increments. Both are examples of a full-frequency sweep conducted over the course of a single acquisition.

Representative transient signals extracted for tetraoctylammonium (T8A) for both linear and sawtooth sweeps are shown in FIG. 19. Over the course of a single acquisition, the linear sweeps modulate at 5-2005 Hz over 2000 mass scans. In contrast to the linear sweeps, the sawtooth sweeps do the same in just 400 points after minimizing the effective sampling frequency. Assuming a constant number of total points, the shortened sweep may be carried out multiple times. In the example shown in FIG. 19, the sampling-optimized sweep is repeated five times. However, this many points may not be necessary for application, one may consider optimizing the number of total points vs sawtooth repetitions within a nonlinear sweep. These are flexible parameters and should be set based on acceptable resolving power and SNR values while also maintaining an appropriate effective sampling rate. 11 Furthermore, this will also depend on the type of analysis that is being conducted, as will be discussed below. For single ions with high-SNR transients, the full sawtooth sweep will be treated as a single sinusoid. For multiple isobaric ions with low-SNR transients the sawtooth signal will be split into even segments and ensemble-averaged to produce a single transient with increased SNR, albeit at a reduced number of points. It is important to note that for lower mass ions, effective sampling frequency minimization, as shown in FIG. 19, may be sufficient. However, for larger mass ions, it may be necessary to employ this measure in conjunction with a lower terminal frequency as they will experience signal attenuation at much lower terminal frequencies.

Single Ion Monitoring with High-SNR Transients

First, we will establish why sawtooth modulation is possible for extending the range of a single ion's transient. For any arbitrary ion, its characteristic drift time will be defined by experimental parameters, viz. temperature, pressure, electric field homogeneity, and electric field strength. This drift time is the inverse of the rate at which an ion traverses the drift region; in the case of a dual-gate IMS, the drift region is defined by the distance between each set of ion gates. For clarity, this concept can be described as the traversal frequency of the ion. Intuitively, if the frequency at which the gates are being modulated is an integer multiple of the traversal frequency (i.e., traversal frequency harmonics), the ion will arrive at the second gate during an opening event and will be admitted into the mass spectrometer. This is precisely what the FT-IMS experiment exploits via the synchronous gate modulation; a range of frequencies is swept through for the gates to modulate at these harmonics. So, it follows that for a given rate at which gate modulation frequencies are swept through (i.e., the slope of the frequency sweep, Hz/s), this sweep rate will determine the frequency at which we modulate at the traversal frequency harmonics—we will call this the transient frequency. We can now arrive at the final observation that assuming a constant traversal frequency, the resulting oscillating transient can be extended via a sawtooth-shaped sweep where all segments in the sweep are at the same slope, which, therefore, results in a constant transient frequency. At this point, the resulting signal can be treated as a simple damped sinusoid.

A subtle but important note here is that the magnitude of the frequency sweep slope is the key metric for the determination of the transient frequency, as it does not matter whether frequency harmonics are iterated through in a forward (e.g., 5-8005 Hz) or reverse order (e.g., 8005-5 Hz). Furthermore, we acknowledge that this explanation is binary in nature regarding ion admission past the second ion gate. The intention is to illustrate the importance of maintaining the same frequency sweep slope across each segment of the sawtooth sweep. For an in-depth discussion of fundamental FT-IMS concepts, we refer readers to the seminal work by Knorr et al. and our recent work in the context of FT-IM-MS.10,11

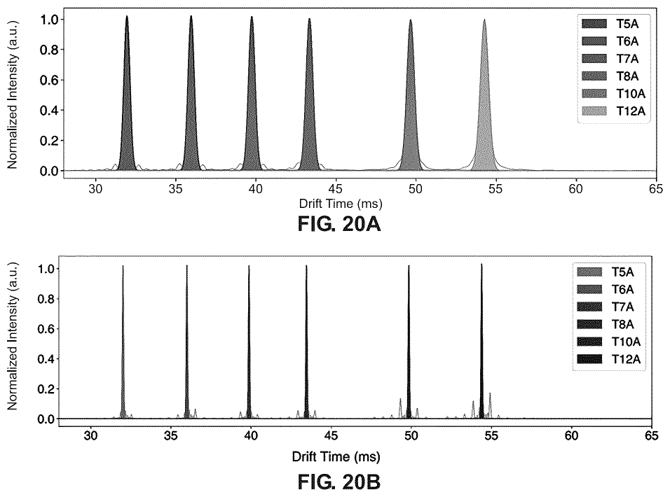

FIG. 20 shows arrival time distribution for six TXA salts using (a) linear sweeps and (b) sawtooth sweeps. Linear sweep data was collected using a frequency range of 5-2005 Hz over 2000 scans. Sawtooth sweep data was collected using a frequency range of 5-2005 Hz over 400 scans and repeated five times for a total of 2000 points. Filled-in peak areas are Gaussian fits of the raw reconstructed data shown in grey.

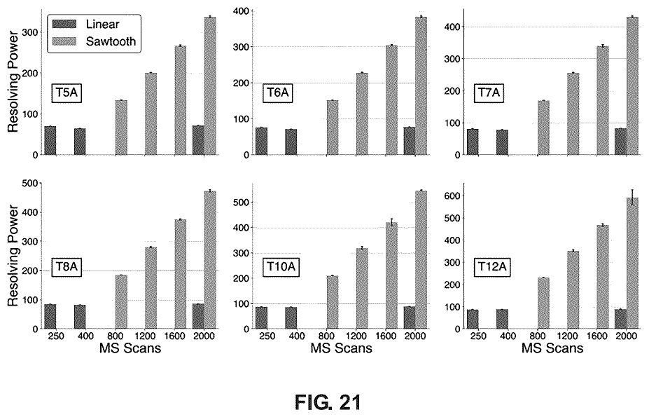

We will first cover the case where only one ion exists per extracted m/z range. FIG. 20 subplots (a) and subplots (b) show, respectively, the reconstructed arrival time distributions (ATD) for six TXA salts using a linear frequency sweep of 5-2005 Hz at 2000 scans and sawtooth sweeps with a frequency range of 5-2005 Hz at 400 scans repeated five times. For the sawtooth sweep experiments, we utilized the full length of the sawtooth frequency sweep, for purposes of maximizing the number of oscillations (i.e., periods) present in the transient. A direct result was an increase in the precision of the assigned frequency and, by extension, the drift time for each of the selected ions. The ATD peaks reconstructed from linear sweeps show average resolving powers between 64-88, whereas with the full sawtooth transient, we achieved resolving powers exceeding 500. This is shown, for example, by representative data graphs in FIG. 21.

A current point of investigation is the minimization of sidelobes seen for some of the higher mass ions, such as T10A and T12A, for the sawtooth sweeps. These sidelobes are due to spectral leakage caused by large amplitude jumps due to concatenating transient segments. Efforts in ameliorating these artifacts will include data-driven apodization routines such as those seen for linear sweeps.26 Due to the increased attenuation in the transient for larger ions, it can be argued that this procedure is currently limited to smaller ions. However, one could truncate at a much lower terminal frequency to limit the amount of attenuation seen at the end of each sawtooth segment, which would result in less drastic amplitude jumps. These effects are shown in FIG. 21 and FIG. S3 where the transients for T5A maintain larger amplitude and show minimal spectral leakage-related artifacts relative to larger ions such as T10A or T12A.

FIG. 21 shoes a resolving power for TXAs using linear and sawtooth sweeps at various lengths. The frequency range for linear sweeps was 5-2005 Hz, the sawtooth sweeps also modulated between 2-2005 Hz but at 400 points repeated five times. Each value is the average of five replicates and error bars represent the standard deviation.

Data in FIG. 21 shows the resolving power increases for sawtooth modulation in comparison to traditional linear sweeps. The maximum number of points used for both sweep types was 2000 mass scans, as it was the most comparable to lengths used in previous FT-IM-MS work and thus provided a good baseline for experimental length.3-5 The length of 400 scans for the sawtooth sweeps is not present as a single 400-scan segment of a sawtooth sweep is simply a linear 400-scan segment. Linear data was also taken at 250 scans as it was at about the absolute minimum number of points required to accurately reconstruct the reconstructed arrival time distribution. 11 The sawtooth sweeps consisted of 2000 scans divided into five 400-scan segments, each of which was truncated accordingly to generate the data for 800, 1200, and 1600 scans. As shown in FIG. 21, the resolving power of each of the analytes remained constant for the linear sweeps regardless of the number of points used. This is to be expected as the frequency range (5-2005 Hz) was constant and was chosen as the point where the transient for the lower mobility ions started to decay considerably. However, by showing both a lower and upper bound on the number of points used, this illustrates that effective sampling frequency can be minimized for high-SNR transients with little effect on resolving power. In contrast to this, sawtooth modulation shows large increases in resolving power as the number of points is increased. While additional gains in speed will emerge as the scan times of ion trap mass analyzers concurrently increase, the sawtooth modulation at just 800 scans achieves resolving powers well beyond those from linear sweeps. Although 800 scans (two sawtooth segments) is a two-fold increase in time relative to a single 400-point segment, more than a two-fold increase in resolving power is seen in some cases. This is especially pronounced for the larger analytes (i.e., T12A) with transients that decay at lower terminal frequencies. The relative timescales associated with this, however, will depend on the mass spectrometer employed. In our experiments, an increase of 400 points will result in an increase of ˜32 seconds (81 ms average scan time).

It is known that increasing the observation time (and equivalently, the number of periods observed) of a time-domain signal will decrease peak widths in the frequency domain. Therefore, provided the experimentalist has enough time, these single-ion transients can be extended to arbitrary lengths using sawtooth modulation, to continue increasing the resolving power. That is, assuming all experimental conditions remain the same and processing of each segment is handled appropriately. Here we want to point out that although we can continue to increase the resolving power of a single peak in the ATD, this does not necessarily mean that resolution between two adjacent peaks in the ATD will also increase, as this is dictated by the frequency range gates are modulated at. Increasing the frequency range is equivalent to increasing the effective observation time of a single transient. A longer observation window will allow the small difference in similar frequencies to propagate and eventually start to interfere destructively, which will then translate to greater separation between the two peaks. However, as already mentioned, frequency ranges must eventually be truncated as high attenuation appears at these high modulation frequencies. To this end, for single ion transients, this method is still effective for highly precise drift time measurements as the sawtooth sweep measures the residence time of the ion continuously throughout the experiment with minimal signal attenuation.

Another important note is that the overall trend shown in FIG. 21, where resolving powers increase with ion mass/size, should be extrapolated to other chemical systems with great care. This is a set of small ions, and their transients will experience less attenuation overall at higher terminal frequencies. As such, the increasing resolving power is realized because the transient frequency of a slower (and in general, higher mass) ion will be higher, and the resulting transient will contain more oscillations overall. This will translate to a narrower peak after the Fourier transform. Transients with well-defined oscillations at high frequencies become increasingly less common with increasing ion size. Larger and more dynamic biomolecules will be subject to drastic signal attenuation at much lower frequencies and thus result in fewer periods over a given frequency range. Furthermore, these associated transients will have low SNR and may require a different method for processing, as described below.

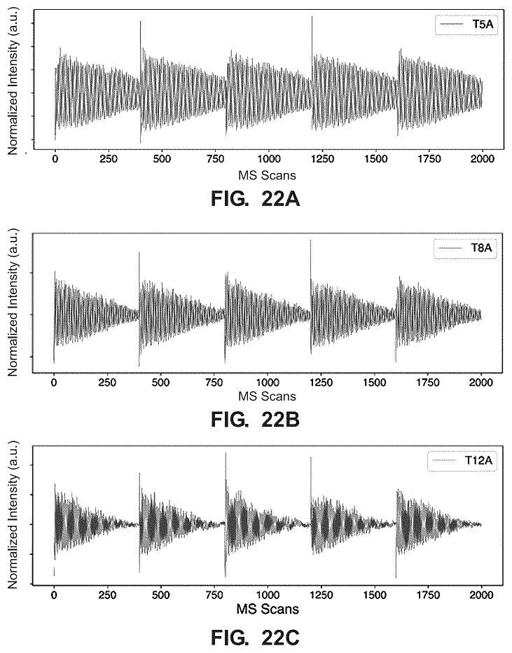

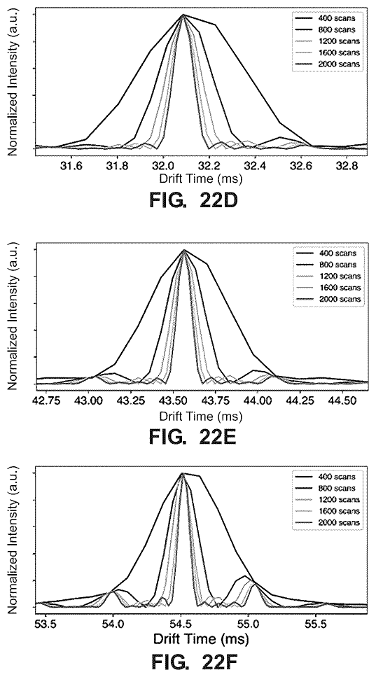

FIG. 22 shows transients (a-c) and reconstructed arrival time distributions (d-f) for TXAs generated from a single sawtooth sweep modulating at 5-2005 Hz over 400 MS scans at five repetitions. Each ATD shows the increased resolving power as the number of transient points is increased from 400 to 2000. As the number of sawtooth segments is increased, the number of amplitude jumps between the segments also increases. These amplitude jumps result in artifacts post-Fourier transform (i.e., spectral leakage). This is shown most prominently for T12A.

Multiple Ion Monitoring with Low-SNR Transients

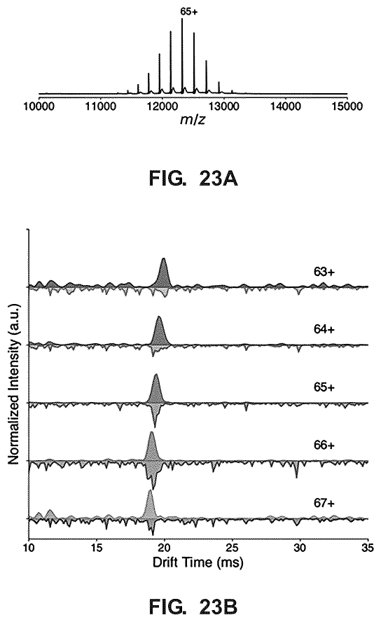

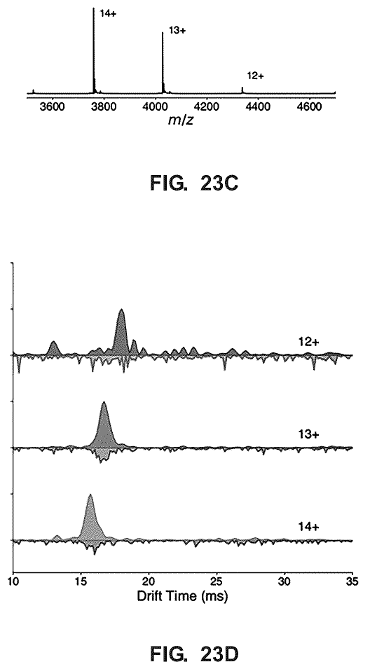

FIG. 23 shows mass spectrum for (a) GroEL and (b) streptavidin and the reconstructed ATDs for multiple charge states in panes (b) and (c), respectively. ATD reconstruction for GroEL was limited to the 63-67+ charge states as all other charge states yielded signals of SNR far too low for both sweeping methods. ATDs for sawtooth sweeps (four 500-scan segments at 5-1755 Hz) are plotted on the positive axis, and peaks on the inverted axis are reconstructed ATDs from linear sweeps (5-7005 Hz).

While treating a sawtooth transient as a simple damped sinusoid, as described above, works well for high-SNR signals, such treatment is not readily generalized for low-SNR transients composed of many frequencies. There are two primary factors limiting these types of signals. First, because the transient is low-SNR, the low amplitude oscillations make determining its phase ambiguous. Second, even if transient SNR were increased via a bandpass filter, correcting for phase would become increasingly difficult as the number of frequencies contained within a single transient is increased. To this end, we recommend ensemble averaging of each of the sawtooth transient segments in addition to minimizing the terminal frequency and effective sampling frequency. Despite higher terminal frequencies resulting in higher resolution 2,3, this approach favors SNR over resolution. After all, resolution is a moot point if there is no peak to observe.

FIG. 23 shows the mass spectrum and arrival time distributions for GroEL and streptavidin using linear and sawtooth sweeps. Linear sweep experiments used a frequency range of 5-7005 Hz, and the sawtooth sweeps were composed of four segments with a total frequency range of 5-1755 Hz each. For both GroEL and streptavidin, the reconstructed ATDs generated from sawtooth sweeps show clearly defined peaks above baseline noise, in stark contrast to those reconstructed from linear sweeps. In some cases, no real peak is reconstructed from the linear sweeps, and if a discernible peak is reconstructed, it's difficult to distinguish it from noise. By simply shrinking the frequency range, sawtooth modulation may be utilized for efficient single-acquisition signal averaging experiments. Practices can shrink the frequency range without any signal averaging for GroEL and streptavidin, respectively. However, signal averaging may be preferred when transients are noisy. It precisely is due to this difficulty in generating higher SNR transients that charge states 60-62+, 68+, and 69+ for GroEL were not used as they were too noisy for both linear and sawtooth sweeps. Determining how many sawtooth segments are required to achieve reasonable SNR may be empirically determined. It may be a difficult metric to estimate as the quality of the ion transient will vary between different analytes and even between charge states of the same analyte. For example, a 500-scan sweep enabled us to reconstruct a high SNR ATD for the 66+ charge state of GroEL. In contrast, the 67+ charge state of GroEL requires 1500-2000 (3-4 500-point sawtooth segments) scans to achieve acceptable SNR. A key step in generating sawtooth sweeps for both low- and high-SNR transients is minimization of the effective sampling frequency. 11 This will drastically lower the number of points needed for each sawtooth segment and, by extension, any full sweep composed of multiple segments.

### Example 2—Conclusion

As an alternative to linear frequency modulation, where a predefined frequency range is swept through only once, nonlinear sawtooth modulation strategies were employed to increase the data density of FT-IM-MS signals by modulating at frequencies that yield well-defined oscillations. Increased time efficiency is also realized via a combination of sawtooth modulation, frequency range optimization, and effective sampling rate reduction. As a result, SNR and resolving power were increased for low-SNR and high-SNR signals, respectively, within a single acquisition of the same length as the linear sweep counterparts. Although a one-size-fits-all approach can be taken for generating a frequency sweep with varying degrees of success, here we emphasize a tailored and systematic approach for generating frequency sweeps for maximizing the information density of experiments, regardless of sweep type. As it stands, multiplexed ion mobility experiments, in general, are limited by the ever-present inefficiencies of current gating mechanisms, and as such, large leaps in resolving power, resolution, and SNR will be unlikely without further innovations in ion gating. Until such developments arise, future efforts will be primarily focused on alternative methods of modulating ions while maintaining the concomitant benefits of multiplexing.

### Example 2—References

(1) Dietiker, R.; di Lena, F.; Chen, P. Fourier Transform Ion Mobility Measurement of Chain Branching in Mass-Selected, Chemically Trapped Oligomers from Methylalumoxane-Activated, Metallocene-Catalyzed Polymerization of Ethylene. J. Am. Chem. Soc. 2007, 129 (10), 2796-2802.
(2) Clowers, B. H.; Siems, W. F.; Yu, Z.; Davis, A. L. A Two-Phase Approach to Fourier Transform Ion Mobility Time-of-Flight Mass Spectrometry. Analyst 2015, 140 (20), 6862-6870.
(3) Morrison, K. A.; Siems, W. F.; Clowers, B. H. Augmenting Ion Trap Mass Spectrometers Using a Frequency Modulated Drift Tube Ion Mobility Spectrometer. Anal. Chem. 2016, 88 (6), 3121-3129.
(4) Poltash, M. L.; McCabe, J. W.; Shirzadeh, M.; Laganowsky, A.; Clowers, B. H.; Russell, D. H. Fourier Transform-Ion Mobility-Orbitrap Mass Spectrometer: A Next-Generation Instrument for Native Mass Spectrometry. Anal. Chem. 2018, 90 (17), 10472-10478.
(5) McKenna, K. R.; Clowers, B. H.; Krishnamurthy, R.; Liotta, C. L.; Fernández, F. M. Separations of Carbohydrates with Noncovalent Shift Reagents by Frequency-Modulated Ion Mobility-Orbitrap Mass Spectrometry. J. Am. Soc. Mass Spectrom. 2021, 32 (9), 2472-2780.
(6) Clowers, B. H.; Hill, H. H., Jr. Mass Analysis of Mobility-Selected Ion Populations Using Dual Gate, Ion Mobility, Quadrupole Ion Trap Mass Spectrometry. Anal. Chem. 2005, 77 (18), 5877-5885.
(7) Tang, X.; Bruce, J. E.; Hill, H. H., Jr. Design and Performance of an Atmospheric Pressure Ion Mobility Fourier Transform Ion Cyclotron Resonance Mass Spectrometer. Rapid Commun. Mass Spectrom. 2007, 21 (7), 1115-1122.
(8) Keelor, J. D.; Zambrzycki, S.; Li, A.; Clowers, B. H.; Fernández, F. M. Atmospheric Pressure Drift Tube Ion Mobility-Orbitrap Mass Spectrometry: Initial Performance Characterization. Anal. Chem. 2017, 89 (21), 11301-11309.
(9) Revercomb, H. E.; Mason, E. A. Theory of Plasma Chromatography Gaseous Electrophoresis.pdf. Anal. Chem. 1975, 47 (7), 970-983.
(10) Knorr, F. J.; Eatherton, R. L.; Siems, W. F.; Hill, H. H., Jr. Fourier Transform Ion Mobility Spectrometry. Anal. Chem. 1985, 57 (2), 402-406.
(11) Cabrera, E. R.; Clowers, B. H. Considerations for Generating Frequency Modulation Waveforms for Fourier Transform-Ion Mobility Experiments. J. Am. Soc. Mass Spectrom. 2022, 33 (10), 1858-1864.
(12) Puton, J.; Knap, A.; Siodłowski, B. Modelling of Penetration of Ions through a Shutter Grid in Ion Mobility Spectrometers. Sens. Actuators B Chem. 2008, 135 (1), 116-121.
(13) Kirk, A. T.; Grube, D.; Kobelt, T.; Wendt, C.; Zimmermann, S. High-Resolution High Kinetic Energy Ion Mobility Spectrometer Based on a Low-Discrimination Tristate Ion Shutter. Anal. Chem. 2018, 90 (9), 5603-5611.
(14) Kwantwi-Barima, P.; Reinecke, T.; Clowers, B. H. Increased Ion Throughput Using Tristate Ion-Gate Multiplexing. Analyst 2019, 144 (22), 6660-6670.
(15) Kwantwi-Barima, P.; Reinecke, T.; Clowers, B. H. Enabling Resolution of Isomeric Peptides Using Tri-State Ion Gating and Fourier-Transform Ion Mobility Spectrometry. Int. J. Ion Mobil. Spectrom. 2020, 23 (2), 133-142.
(16) Butalewicz, J. P.; Sanders, J. D.; Clowers, B. H.; Brodbelt, J. S. Improving Ion Mobility Mass Spectrometry of Proteins through Tristate Gating and Optimization of Multiplexing Parameters. J. Am. Soc. Mass Spectrom. 2023, 34 (1), 101-108.
(17) Smith, B. L.; Boisdon, C.; Young, I. S.; Praneenararat, T.; Vilaivan, T.; Maher, S. Flexible Drift Tube for High Resolution Ion Mobility Spectrometry (Flex-DT-IMS). Anal. Chem. 2020, 92 (13), 9104-9112.
(18) Naylor, C. N.; Cabrera, E. R.; Clowers, B. H. A Comparison of the Performance of Modular Standalone Do-It-Yourself Ion Mobility Spectrometry Systems. J. Am. Soc. Mass Spectrom. 2023, 34 (4), 586-594.
(19) Reinecke, T.; Clowers, B. H. Implementation of a Flexible, Open-Source Platform for Ion Mobility Spectrometry. HardwareX 2018, 4, e00030.
(20) Langejuergen, J.; Allers, M.; Oermann, J.; Kirk, A.; Zimmermann, S. High Kinetic Energy Ion Mobility Spectrometer: Quantitative Analysis of Gas Mixtures with Ion Mobility Spectrometry. Anal. Chem. 2014, 86 (14), 7023-7032.
(21) McCabe, J. W.; Mallis, C. S.; Kocurek, K. I.; Poltash, M. L.; Shirzadeh, M.; Hebert, M. J.; Fan, L.; Walker, T. E.; Zheng, X.; Jiang, T.; Dong, S.; Lin, C.-W.; Laganowsky, A.; Russell, D. H. First-Principles Collision Cross Section Measurements of Large Proteins and Protein Complexes. Anal. Chem. 2020, 92 (16), 11155-11163.
(22) Poltash, M. L.; McCabe, J. W.; Shirzadeh, M.; Laganowsky, A.; Russell, D. H. Native IM-Orbitrap MS: Resolving What Was Hidden. Trends Analyt. Chem. 2020, 124. https://doi.org/10.1016/j.trac.2019.05.035.
(23) Cabrera, E. R.; Clowers, B. H. Synchronized Stepped Frequency Modulation for Multiplexed Ion Mobility Measurements. J. Am. Soc. Mass Spectrom. 2022, 33 (3), 557-564
(24) Chambers, M. C.; Maclean, B.; Burke, R.; Amodei, D.; Ruderman, D. L.; Neumann, S.; Gatto, L.; Fischer, B.; Pratt, B.; Egertson, J.; Hoff, K.; Kessner, D.; Tasman, N.; Shulman, N.; Frewen, B.; Baker, T. A.; Brusniak, M.-Y.; Paulse, C.; Creasy, D.; Flashner, L.; Kani, K.; Moulding, C.; Seymour, S. L.; Nuwaysir, L. M.; Lefebvre, B.; Kuhlmann, F.; Roark, J.; Rainer, P.; Detlev, S.; Hemenway, T.; Huhmer, A.; Langridge, J.; Connolly, B.; Chadick, T.; Holly, K.; Eckels, J.; Deutsch, E. W.; Moritz, R. L.; Katz, J. E.; Agus, D. B.; MacCoss, M.; Tabb, D. L.; Mallick, P. A Cross-Platform Toolkit for Mass Spectrometry and Proteomics. Nat. Biotechnol. 2012, 30 (10), 918-920.
(25) Cabrera, E. R.; Laganowsky, A.; Clowers, B. H. FTflow: An Open-Source Python GUI for FT-IM-MS Experiments. J. Am. Soc. Mass Spectrom. 2023, 34 (4), 790-793.
(26) Sanders, J. D.; Butalewicz, J. P.; Clowers, B. H.; Brodbelt, J. S. Absorption Mode Fourier Transform Ion Mobility Mass Spectrometry Multiplexing Combined with Half-Window Apodization Windows Improves Resolution and Shortens Acquisition Times. Anal. Chem. 2021, 93 (27), 9513-9520.

### Example 3

### Considerations for Generating Frequency Modulation Waveforms for Fourier Transform-Ion Mobility Experiments

By casting the information regarding an ion population's mobility in the frequency domain, the coupling of time-dispersive ion mobility techniques is now imminently compatible with slower mass analyzers such as ion traps. Recent reports have detailed the continued progress towards maximizing the efficiency of the Fourier transform ion mobility-mass spectrometry (FT-IM-MS) experiments but few reports have outlined the intersection between the practical considerations of implementation against the theoretical limits imposed by traditional signal processing techniques. One of the important concerns for Fourier based multiplexing experiments is avoiding signal aliasing as a product of undersampled signals that may occur during data acquisition. In addition to traditional considerations such as detector sampling frequency, the limitations (i.e., maximum measurable drift time) imposed by experimental mass scan duration, and the frequency sweep used for ion gate modulation must also be assessed. This work aims to connect the fundamental underpinnings of FT-IM-MS experiments and the associated experimental parameters that are encountered when coupling the comparatively fast separations in the mobility domain with the slower m/z scanning common for ion trap mass analyzers. In addition to stating the relevant theory that applies to the FT-IM-MS experiment, this report highlights how aliased signals will manifest post Fourier transform in reconstructed arrival time distributions and calculated mobilities.

### Introduction

Ion mobility spectrometry is a gas-phase chemical separation technique with the ability to separate ion populations on the millisecond timescale based on differences in their mobility coefficients. 1 An ion's mobility is determined by measuring its velocity under a weak, uniform electric field in the presence of an inert drift gas. Through a series of simplifying assumptions experimental mobilities may also be related to an ion-neutral collision cross section (CCS).2,3 Sensitivity to CCS affords ion mobility spectrometry structural insights otherwise difficult to attain in the mass domain, making IMS a highly complementary method to mass spectrometry. The information rich datasets that can be produced from ion mobility-mass spectrometry (IMS-MS) experiments have been used to great effect in glycomics,4,5 lipidomics,6,7 and proteomics conformational studies.8-11 While successful implementation of IMS-MS has been realized, augmenting mass spectrometers, particularly ion traps, has proven to be a challenge due to their mismatched duty cycles. Ion traps perform mass scans at a rate too slow for mass information to be nested into the mobility domain. Furthermore, another commonly seen method of operation has been mobility discrimination prior to mass analysis through time-delayed modulation of a second ion gate, a method that requires very long experimental times. 12 In contrast to previous approaches, Fourier based multiplexing has drastically shortened experimental timescales and eased the integration of front-end ion mobility separations prior to mass analysis (FT-IM-MS).13,14 Additionally, multiplexed experiments have inherent benefits over traditional signal-averaged experiments such as improvements in signal-to-noise ratio (SNR) and increased ion throughput. 15-17 However, due to the increased complexity of generated datasets, care must be taken when interpreting FT-IM-MS results in order to fully leverage the benefits of these multiplexed experiments. The work discussed henceforth aims to inform the reader on the relationship between key experimental parameters in an FT-IM-MS experiment and the mobility data information that may accurately be extracted from the resulting signal. Overlooking variables such as mass scan duration and frequency sweep rate may lead to improper reconstruction of arrival time distributions. The consequences of which will lead to incorrect conclusions regarding related metrics such as CCS, a metric of particular importance for studies concerned with differentiating structure of large compounds. As the field progresses and new multiplexing variants emerge, a detailed understanding of the existing limitations to the FT-IM-MS experiment are necessary. This work highlights a generalizable strategy to evaluate the fidelity of a frequency modulated ion signal and establishes a practical foundation to further enhance the efficiency of ion mobility-mass spectrometry experiments.

### Theory and Relevant Equations

In order to carry out an FT-IM-MS experiment, the IMS must have two ion gates or modulating electrodes bracketing the drift region. In the classical implementation of the techniques, these ion gates must be simultaneously modulated according to a user-defined frequency sweep typically starting at 5 Hz (i.e., non-zero) and linearly increasing to a desired terminal frequency, (e.g., 8005 Hz). As an ion traverses the plane of the first ion gate and enters the drift region, its drift time will determine when the ion will reach the second gate. For the ion to make it across the second gate and on to mass analysis, the analyte's drift time must be resonant with the frequency at which the gates are being modulated. Stated differently, for a given frequency, only a certain subset of ions will have drift times that will allow for their arrival at the second gate to align with an opening event; all other ions will arrive while it is closed and be neutralized. The relationship between an ion's drift time and resonant frequencies first described by Knorr and Siems is as follows:^{14,18}

$${S ( v )}_{ma x} = 0.5 {I}_{0} when v = 0 , 1 / {t}_{d} , 2 / {t}_{d} , 3 / {t}_{d} … \qquad Equation ( 6 )$$

$${S ( v )}_{m i n} = 0 when v = 1 / 2 {t}_{d} , 3 / 2 {t}_{d} , 5 / 2 {t}_{d} … \qquad Equation ( 7 )$$

Where S(v)ₘₐₓ and S(V)ₘᵢₙ are the ions signal intensity, v is the gate modulation frequency, and ta is the ions drift time. There are two methods in which ion gate modulation may be conducted: continuous modulation and discrete stepwise modulation. In continuous modulation experiments, the sweeping of frequencies is independent of the mass spectrometer's scan rate where only the start and the end of an experiment are synchronized.^{5,13,19} Another recently described method, discrete stepwise frequency modulation, requires all mass scans and the iteration of frequencies to be synchronized throughout the entirety of the experiment. This is done in order to unambiguously assign ion-current intensity to single frequencies within the sweep.²⁰ Due to the increased precision of the stepped frequency modulation approach, work and discussions within this paper will be within the context of the stepped modulation approach. However, the principles discussed here also apply to continuous frequency sweeps, albeit to a lesser extent as ion-current derived from unsynchronized modulation cannot be precisely defined as per Equations (6) and (7).

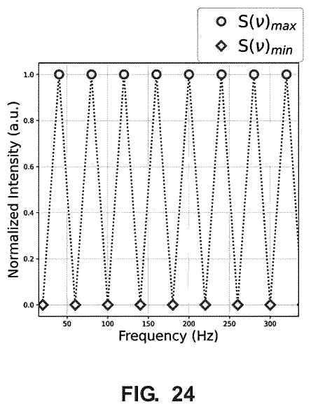

As the sequence of frequencies is iteratively changed, the recorded ion current will take the form of a triangle wave (i.e., the cross-correlation between the two square waves used for modulation), the frequency of which is directly proportional to the frequency sweep rate. The rate at which frequencies are swept determines the frequency at which S(v)ₘᵢₙ and S(v)ₘₐₓ values are observed. An example of this triangle wave is shown in FIG. 24. To assist the accuracy of capturing the oscillating pattern of the ion current, it is preferable that the number of frequencies be sufficient, where all S(V)ₘₐₓ and S(V)ₘᵢₙ are measured for all ions in the system for which an accurate mobility is desired. If there is an insufficient number of measurements between periods of this oscillating signal (i.e., undersampled), then the resulting signal will appear to oscillate at a different frequency. This new perceived signal is known as an alias of the true signal. A subsequent Fourier transform of this aliased signal will generate peaks at incorrect frequencies that translate to erroneous drift times when reconstructing the arrival time distribution. Stated differently, there is a minimum sampling rate at which ion gates must be modulated to fully capture the true signal. The highest frequency signal that a particular sampling frequency may accurately capture is commonly known as the Nyquist frequency.²¹ The Nyquist frequency is defined as half the sampling frequency. For example, if an instrument is scanning at 5 Hz, then the Nyquist frequency is 2.5 Hz. In other words, to fully capture a signal, the sampling frequency must be, at a minimum, 2× the signal's true frequency. It should be understood that generally, sampling frequency refers to the temporal spacing of acquired data points; this definition is not directly applicable to these experiments because ion current is being modulated via the frequency spacing of the user-defined sweep. However, because frequency is swept through time in a linear manner, one can extend this definition to these experiments. Consequently, it will be understood that the space between sequential frequencies in the sweep must be low enough to capture full signal oscillations and record S(v)ₘᵢₙ and S(v)ₘₐₓ. The maximum drift time in the reconstructed arrival time distribution (ATD) that may be captured is determined by both the Nyquist frequency and the frequency sweep rate. This relationship is shown in Equation 8:

$${t}_{d , ma x} = \frac{{f}_{N}}{sweep rate} \qquad Equation ( 8 )$$

Where t_{d,max} is the maximum recoverable drift time (s), f_{N} is the Nyquist frequency (Hz), and sweep rate (Hz/s) is the rate at which the frequencies are iterated through. This relationship states that for a given sampling frequency, increasing the frequency sweep rate will lower the maximum drift time that can be accurately captured. In practice, the whole x-axis vector (Hz) generated via Fourier transform is divided by the sweep rate in order to reconstruct the ATD. If a signal with a frequency beyond the Nyquist limit is present, a Fourier transform of this signal will yield an aliased frequency. The relationship between a signal's alias and the true frequency is shown by Equation 9:²²⁻²⁴

$${f}_{alias} = \vert {nf}_{s} - {f}_{true} \vert where n = 1 , 2 , 3 , … \qquad Equation ( 9 )$$

Where fₐₗᵢₐₛ (Hz) is the perceived frequency of the true signal's frequency, fₜᵣᵤₑ (Hz), at a static sampling frequency fₛ (Hz). There may be an infinite number of aliases for a given frequency and a specific alias is determined by the integer value n. Using this relationship, one can determine whether a particular peak in the frequency domain is a product of an aliased signal. An example of this calculation is provided in the discussion section of this example. If the drift time of the slowest analyte, duration of each mass scan, and terminal frequency are known, then Equation 10 may be used to determine the minimum amount of time required in order to iterate through the frequency sweep:

$${t}_{ex p} = \frac{{t}_{d , m ax} {f}_{term}}{{f}_{N}} \qquad Equation ( 10 )$$

Where tₑₓₚ (s) is the minimum length for the given experiment, t_{d,max} (s) is the maximum drift time to be recorded, and fₜₑᵣₘ (Hz) is the frequency at which the sweep will terminate. Knowing tₑₓₚ and the length of each MS scan, the number of scans required may be calculated.

### Experimental Methods

### Ion Mobility Spectrometer and Linear Ion-Trap Mass Spectrometer

Ion mobility experiments were conducted at ambient conditions (˜690-700 Torr, ˜20° C.) using an atmospheric pressure dual-gate PCB ion mobility spectrometer (IMS) described by Reinecke and Clowers.25 The length of the entire IMS assembly measured 27.4 cm and operated at an electric field gradient of ˜490 V cm-1 for all experiments. The drift region of the IMS was defined by the spacing between both tri-grid shutter ion gates at 17.4 cm apart, leaving a 10 cm desolvation region at the front end. The ion gates were each driven by open-source pulsers previously described.26,27 The back end of the drift region was interfaced with a linear ion trap mass spectrometer (LTQ, Thermo Scientific, San Jose, CA). A counterflow of dried and purified nitrogen gas at 2.5 L min-1 was introduced at the back end of the drift region at the interface between the IMS and LTQ. It is important to note that this flow rate was necessary due to the ˜2 L min-1 conductance of the LTQ inlet.

### Chemicals and Reagents

Analytes for these experiments were the following tetraalkylammonium (TXA) salts (Sigma-Aldrich, St. Louis, MO): tetrapentylammonium bromide (T5A), tetrahexylammonium bromide (T6A), tetraheptylammonium bromide (T7A), tetraoctylammonium bromide (T8A), tetrakisdecylammonium bromide (T10A), and tetradodecylammonium bromide (T12A). All TXA salts were mixed at a concentration of 1 μM in 95:5 acetonitrile and water with 0.1% formic acid. Analyte solutions were electrosprayed into the desolvation region via a glass capillary (inner diameter of 75 μm) biased +2500 V relative to the first electrode of the IMS.

### Generating Frequency Sweeps and Data Analysis

Custom Python scripts were used to create “.csv” files containing frequency sweeps used for all experiments. Frequency sweeps were all generated with starting frequencies of 5 Hz and terminal frequencies of 7505 Hz at lengths of 2000, 1500, 1000, 674, 630, 539, 494, 449 points. These lengths were chosen in order to successively alias each analyte. The sweep files were loaded onto an Arduino-compatible microcontroller (Wio Terminal, Seeedstudio) with firmware developed in-house.28 The microcontroller was interfaced with an Analog AD9850 waveform generator to drive the ion gates. Synchronization between frequency iteration and MS scans was performed using the TTL (transistor-transistor logic) output from the LTQ and used as a trigger for the microcontrollers to iterate onto the next frequency. Relevant scripts, firmware code, and bill of materials for the frequency generator may be found in our GitHub repository (https://github.com/bhclowers/Stepped-Pulser).

Thermo “.RAW” files were converted to the “.mzML” format via the “msConvertGUI” tool from ProteoWizard.29 Mass spectra and extracted ion chromatograms (XIC) were generated from these files using Python scripts developed in-house. XIC information was extracted by a user-defined mass window of interest (e.g., m/z 466-469) that contained the monoisotopic peak and its associated isotopic peaks. Once the desired XIC was extracted, a quick interpolation procedure was performed to ensure all points within this signal were evenly spaced. This step is important due to imperfect mass scan lengths over the course of an experiment that may vary by a few microseconds. It can be noted that interpolation was carried out using the same number of points as the original data, so as to preserve the original sampling frequency. Once the XIC signal was treated, a Fourier transform of the frequency-modulated signal was performed and the magnitude of the results were used. The x-axis vector (Hz) generated via FT was divided by the experimental frequency sweep rate (Hz/s) to recover an x-axis vector in units of time (s), this results in the proper time vector used for the reconstructed arrival time distribution.

### Results and Discussion

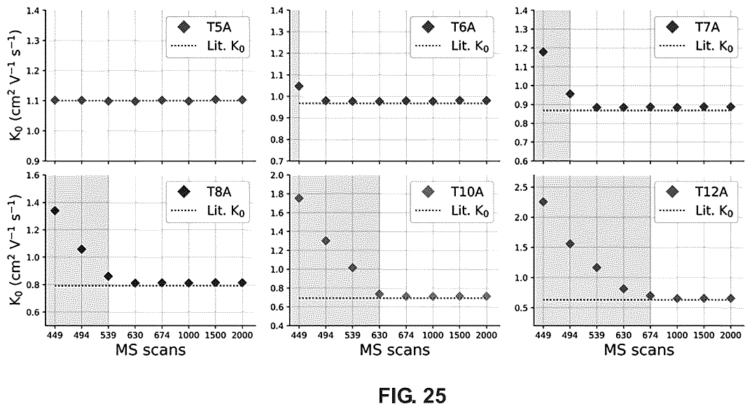

To illustrate deleterious effects of iterating through frequencies too quickly, multiple FT-IM-MS experiments were carried out using different sweep rates. Here, the length of each mass scan was kept constant (˜200 ms) and the frequency sweeps at which ion gates were modulated all started at 5 Hz and terminated at 7505 Hz. In order to change the sweep rate (Hz/s), the number of mass scans used to iterate through this range of frequencies was changed. The greater the number of scans, the longer the experiment and therefore a lower sweep rate, and vice versa. This in turn changes the effective sampling frequency by modifying the spacing between sequential frequencies in the sweep and placing constraints on the number of measurements between S(v)min and S(v)max as shown in FIG. 24. Reduced mobility (K0) values derived from experiments with varied sweep rates are shown in FIG. 25, where the K0 values for each of the analytes is plotted against different experimental lengths. The 2000, 1500, and 1000 scan experiments were chosen using the following considerations—to recover a maximum drift time greater than the required drift time of the slowest analyte (T12A); to establish baseline experimental K0 values; and to ensure they are in agreement with literature.30-32

FIG. 25 shows experimental reduced mobility (K₀) values for T5-T12A collected at different frequency sweep rates compared to literature K₀ (red dotted line).30 All frequency sweeps started at 5 Hz with a terminal frequency of 7505 Hz. To change the sweep rate, the number of scans to reach the terminal frequency was modified. As the number of scans decreases, maximum recoverable drift times also decrease. As a result, aliasing is induced for lower mobility ions earlier than for higher mobility ions (i.e., T12A signal is aliased at 674 scans whereas T7A signal begins to alias at 449 scans). Shaded regions indicate regions where each of the respective analytes will begin to alias. Data points are the average of five replicates. Standard deviation error bars are too small to visualize on the plot but are shown in Table 1.

As experiments were shortened, the effects of aliased frequencies are first seen with the slowest analyte used. At 674 scans, the experimental K0 value for T12A shifts from 0.65 cm2 V-1 s-1 to an incorrect value of 0.70 cm2 V-1 s-1. However, at this sweep rate, correct reduced mobilities are successfully recovered for all other analytes. This shows that the maximum drift time at this sweep rate is somewhere between the drift time of T10A and T12A. As the sweep rate was increased by shortening the experiment to 630 scans both the K0 values for T10A and T12A start deviating from literature values with the value for T12A showing a much larger deviation. Again, showing that at this sweep rate, the maximum recoverable drift time is somewhere between the drift time of T8A and T10A. The effects of increasing sweep rates through increasingly shortened experiments is shown as incorrect reduced mobility values start to sequentially appear for the higher mobility analytes. Additionally, the further the maximum recoverable drift time is from the analytes true drift time, the larger the error in K0. As the sweep rate is continuously increased, the signal for all but one analyte is aliased; T5A continuously remains at steady K0 values for all sweep rates as its frequency in the modulation domain is low enough for it to be sampled at very high sweep rates.

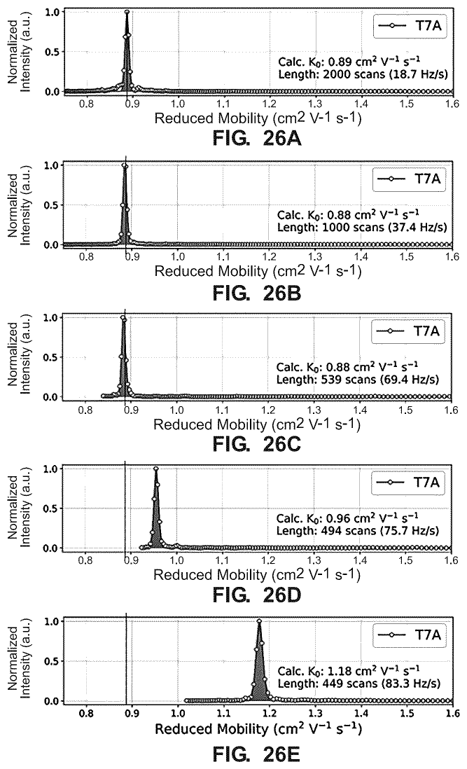

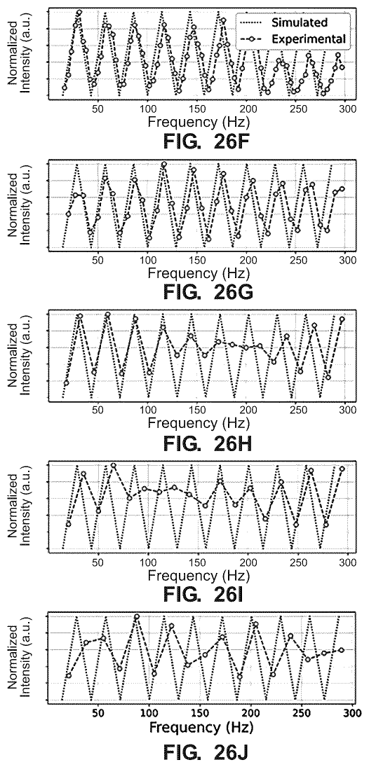

FIG. 26 shows normalized peak intensity for T7A plotted against reduced mobility (K0) at differing frequency sweep rates (a-e). FIG. 26 adjacent plots (f-j) are both the simulated and experimental frequency-modulated ion current from which the arrival time distributions were reconstructed (truncated to 300 Hz to show detail). As shown in FIG. 26 subplots a-c/f-h the sweep rates are low enough to accurately capture the oscillations of the ion current. In contrast, FIG. 26 subplots d-e/i-j show experiments where frequency spacing is too high to accurately capture oscillations and therefore induce signal aliasing. Aliased peaks are shown in red. As the sweep rate is further increased, the error becomes greater. The vertical line spanning plots a-e correspond to the unaliased experimental K0 value for the target analyte. Plot annotations include experimental K0, scan length, and sweep rate.

An example of how aliasing will manifest in the raw frequency-modulated signal and reconstructed arrival time distribution post-Fourier transform is shown in the reduced mobility domain for T7A in FIG. 26. FIG. 26 subplots (a)-(e) show a T7A peak at differing experimental lengths and FIG. 26 subplots (f)-(j) show the frequency-modulated signals that were Fourier transformed to reconstruct the ATD. Datasets taken with sweeps using 2000, 1000, and 539 points were not aliased as shown in subplots a-c, they maintain a steady mobility and closely match those seen in literature. This is expected as the sweep rate for these replicates is low enough to capture a maximum drift time higher than the drift time for T7A (FIG. 25). As the frequency sweep rate (Hz/s) is increased by decreasing the number of scans, the maximum drift time able to be accurately recorded falls below the drift time of T7A and therefore aliasing begins to occur as seen in FIG. 26 subplots d-e. A comparison of the experimental frequency-modulated signals with simulated signals in FIG. 26 subplots f-j show the experimentally recorded signal overlaid on top of the simulated signal calculated using Equations 6 and 7. Close alignment between theoretical and experimental signal is shown FIG. 26 subplots f-h, fully capturing the oscillations. FIG. 26 subplots i-j show signals where the frequency spacing in the frequency sweep is too wide to capture the full oscillations in the signal. Here we aim to further illustrate that during a single experimental acquisition (constant sweep rate), it is possible for the signal of a low-mobility analyte to be aliased while simultaneously recording signal for a different higher mobility analyte that is adequately sampled. In other words, the drift time for this other high-mobility analyte will remain accurate despite aliasing occurring beyond a certain drift time which would distort the observed arrival time for the lower-mobility species.

Table 1 below shows reduced mobility values for all analytes used in experiments. All mobilities were collected using frequency sweeps starting at 5 Hz with a terminal frequency of 7505 Hz. While keeping the frequency range static, sweep rates were modified by changing the number of scans (i.e., total experimental time) that were used to reach the terminal frequency. K0 values highlighted are derived from aliased signals and therefore do not represent the true values. All values shown are averages of five replicates and their standard deviations.

TABLE 1
Experimental Reduced Mobility (K₀, cm² V⁻¹ s⁻¹) Values at Differing Sweep Lengths

| Ion | 449 | 494 | 539 | 630 | 674 | 1000 | 1500 | 2000 | Literature |
|---|---|---|---|---|---|---|---|---|---|
| (m/z) | scans | scans | scans | scans | scans | scans | scans | scans | Values³⁰ |
| T5A | 1.101 ± | 1.101 ± | 1.098 ± | 1.098 ± | 1.101 ± | 1.098 ± | 1.104 ± | 1.103 ± | 1.100 ± |
| (298) | 0.001 | 0.003 | 0.002 | 0.004 | 0.001 | 0.002 | 0.001 | 0.001 | 0.012 |
| T6A | 1.047 ± | 0.979 ± | 0.976 ± | 0.976 ± | 0.979 ± | 0.976 ± | 0.981 ± | 0.980 ± | 0.967 ± |
| (354) | 0.008 | 0.003 | 0.001 | 0.003 | 0.001 | 0.002 | 0.001 | 0.001 | 0.006 |
| T7A | 1.178 ± | 0.955 ± | 0.884 ± | 0.884 ± | 0.886 ± | 0.884 ± | 0.888 ± | 0.887 ± | 0.868 ± |
| (410) | 0.001 | 0.001 | 0.001 | 0.002 | 0.001 | 0.001 | 0.001 | 0.001 | 0.003 |
| T8A | 1.339 ± | 1.057 ± | 0.861 ± | 0.811 ± | 0.813 ± | 0.811 ± | 0.815 ± | 0.815 ± | 0.792 ± |
| (466) | 0.001 | 0.001 | 0.001 | 0.002 | 0.001 | 0.001 | 0.001 | 0.001 | 0.008 |
| T10A | 1.752 ± | 1.300 ± | 1.015 ± | 0.736 ± | 0.711 ± | 0.709 ± | 0.713 ± | 0.712 ± | 0.692 ± |
| (578) | 0.002 | 0.001 | 0.002 | 0.002 | 0.001 | 0.001 | 0.001 | 0.001 | 0.006 |
| T12A | 2.253 ± | 1.556 ± | 1.164 ± | 0.810 ± | 0.697 ± | 0.651 ± | 0.654 ± | 0.653 ± | 0.629 ± |
| (690) | 0.004 | 0.001 | 0.003 | 0.002 | 0.001 | 0.001 | 0.001 | 0.001 | 0.006 |

Table 1 shows all experimental reduced mobility values at different experimental lengths for data shown in FIGS. 25 and 26 as well as their literature values. As shown previously, the calculated K0 values derived from 2000, 1500, and 1000 scan experiments for all analytes closely matched literature values. As the number of scans used for each experiment is decreased, aliasing effects are first seen for 674 scan experiments for T12A and continue as experimental lengths are shortened.

If aliasing is suspected to occur within an experiment, verifying that the K0 values are aliases of the true values is relatively straightforward. For example, the experimental K0 at 2000 scans is 0.65 cm2 V-1 s-1 which corresponds to a drift time of ˜46.4 ms in our instrument. Using Equation 3 and solving for fN, an experiment of 674 scans (sweep rate of 55.47 Hz/s) would require a minimum Nyquist frequency of 2.57 Hz. This is beyond the maximum frequency we can capture at our experimental sampling frequency of 2.48 Hz. With this information, we can use Equation 9 to determine our perceived frequency. With a sampling frequency (fs) of 2.48 Hz, n=2, and the signal's true frequency (ftrue) of 2.57 Hz, the perceived frequency (fₐₗᵢₐₛ) we would see is ˜2.39 Hz. Back calculating using Equation 8, the recovered drift time for a frequency of 2.39 Hz is 43.1 ms which corresponds to a K0 value of 0.70 cm2 V-1 s-1 which matches the incorrect experimentally derived value seen in Table 1 for T12A at 674 scans. Using this train of logic, one can ascertain whether a questionable experimental K0 value has been obtained from an aliased signal.

### Example 3—Conclusion

Successful interpretation of FT-IM-MS results requires full confidence that the frequency sweeps employed allow for accurate measurement of high frequency harmonics beyond those of the largest used compounds. While the likelihood of signal aliasing when working with small, high-mobility analytes (e.g., m/z<300) is low, efforts to prevent aliased signals becomes increasingly important when working with large analytes with low mobilities (e.g., peptides and proteins). Large, low-mobility analytes will not only be susceptible to being aliased but peak structure in the ATD needs to be conserved. While we have yet to see any peak distortion due to aliasing effects, this remains a point to be investigated in future experiments. To this end, FIG. S2 illustrates that there are no changes in peak FWHM related to the extent of aliasing seen in our experiments. Regardless of how aliasing manifests in the final reconstructed arrival time distribution, preventing such experimental error will require an initial evaluation of instrumental parameters (e.g., mass spectrometer scan rate) to create appropriate frequency sweeps with desired maximum drift times. Once acceptable sweep rates are determined, optimization in terms of length and frequency coverage may be performed to optimize for signal-to-noise ratio and resolving power.13,28 Assuming a priori knowledge of the compounds used, it is easy to distinguish whether correct mobilities have been recovered and apply straightforward corrections to the experimental method. If this is not the case and an experimentalist is working with unknowns, it may prove to be useful to introduce large internal standards where the standard is the lowest mobility compound in solution. While the previous point may seem contradictory, one can narrow down the range of mobilities or CCS that may be present in a particular system due to well documented CCS vs m/z trends.33-35 Using this range of mobilities, an appropriate internal lowest-mobility calibrant may be decided upon. We emphasize that such internal standards are for the purpose of determination of maximum recoverable drift times and not CCS calibration. While the temptation to further increase the speed of FT-IM-MS experimental times is understandable, compromises such as those described in this work must be made and limitations of formulated experiments must be considered prior to interpretation of data.

### Example 3 References

(1) Jiang, W.; Chung, N. A.; May, J. C.; McLean, J. A.; Robinson, R. A. S. Ion Mobility-Mass Spectrometry. Encyclopedia of Analytical Chemistry; John Wiley & Sons, Ltd: Chichester, UK, 2019; pp 1-34. doi.org/10.1002/97804700027318.a9292.pub2.
(2) Revercomb, H. E.; Mason, E. A. Theory of Plasma Chromatography Gaseous Electrophoresis.pdf. Anal. Chem. 1975, 47 (7), 970-983.
(3) Siems, W. F.; Viehland, L. A.; Hill, H. H., Jr. Improved Momentum-Transfer Theory for Ion Mobility. 1. Derivation of the Fundamental Equation. Anal. Chem. 2012, 84 (22), 9782-9791.
(4) Morrison, K. A.; Bendiak, B. K.; Clowers, B. H. Enhanced Mixture Separations of Metal Adducted Tetrasaccharides Using Frequency Encoded Ion Mobility Separations and Tandem Mass Spectrometry. J. Am. Soc. Mass Spectrom. 2017, 28 (4), 664-677.
(5) McKenna, K. R.; Clowers, B. H.; Krishnamurthy, R.; Liotta, C. L.; Fernández, F. M. Separations of Carbohydrates with Noncovalent Shift Reagents by Frequency-Modulated Ion Mobility-Orbitrap Mass Spectrometry. J. Am. Soc. Mass Spectrom. https://doi.org/10.1021/jasms.1c00184.
(6) Theisen, A.; Black, R.; Corinti, D.; Brown, J. M.; Bellina, B.; Barran, P. E. Initial Protein Unfolding Events in Ubiquitin, Cytochrome c and Myoglobin Are Revealed with the Use of 213 Nm UVPD Coupled to IM-MS. J. Am. Soc. Mass Spectrom. 2019, 30 (1), 24-33.
(7) Poad, B. L. J.; Zheng, X.; Mitchell, T. W.; Smith, R. D.; Baker, E. S.; Blanksby, S. J. Online Ozonolysis Combined with Ion Mobility-Mass Spectrometry Provides a New Platform for Lipid Isomer Analyses. Anal. Chem. 2018, 90 (2), 1292-1300.
(8) McCabe, J. W.; Shirzadeh, M.; Walker, T. E.; Lin, C.-W.; Jones, B. J.; Wysocki, V. H.; Barondeau, D. P.; Clemmer, D. E.; Laganowsky, A.; Russell, D. H. Variable-Temperature Electrospray Ionization for Temperature-Dependent Folding/Refolding Reactions of Proteins and Ligand Binding. Anal. Chem. 2021, 93 (18), 6924-6931.
(9) Baker, E. S.; Clowers, B. H.; Li, F.; Tang, K.; Tolmachev, A. V.; Prior, D. C.; Belov, M. E.; Smith, R. D. Ion Mobility Spectrometry-Mass Spectrometry Performance Using Electrodynamic Ion Funnels and Elevated Drift Gas Pressures. J. Am. Soc. Mass Spectrom. 2007, 18 (7), 1176-1187.
(10) Uetrecht, C.; Barbu, I. M.; Shoemaker, G. K.; van Duijn, E.; Heck, A. J. R. Interrogating Viral Capsid Assembly with Ion Mobility-Mass Spectrometry. Nat. Chem. 2011, 3 (2), 126-132.
(11) McLean, J. A.; Ruotolo, B. T.; Gillig, K. J.; Russell, D. H. Ion Mobility-mass Spectrometry: A New Paradigm for Proteomics. Int. J. Mass Spectrom. 2005, 240 (3), 301-315.
(12) Clowers, B. H.; Hill, H. H., Jr. Mass Analysis of Mobility-Selected Ion Populations Using Dual Gate, Ion Mobility, Quadrupole Ion Trap Mass Spectrometry. Anal. Chem. 2005, 77 (18), 5877-5885.
(13) Morrison, K. A.; Siems, W. F.; Clowers, B. H. Augmenting Ion Trap Mass Spectrometers Using a Frequency Modulated Drift Tube Ion Mobility Spectrometer. Anal. Chem. 2016, 88 (6), 3121-3129.
(14) Poltash, M. L.; McCabe, J. W.; Shirzadeh, M.; Laganowsky, A.; Clowers, B. H.; Russell, D. H. Fourier Transform-Ion Mobility-Orbitrap Mass Spectrometer: A Next-Generation Instrument for Native Mass Spectrometry. Anal. Chem. 2018, 90 (17), 10472-10478.
(15) Fellgett, P. CONCLUSIONS ON MULTIPLEX METHODS. J. phys., Colloq. 1967, 28 (C2), C2-C165-C2-C171.
(16) Brock, A.; Rodriguez, N.; Zare, R. N. Hadamard Transform Time-of-Flight Mass Spectrometry. Anal. Chem. 1998, 70 (18), 3735-3741.
(17) Jacquinot, P. The Luminosity of Spectrometers with Prisms, Gratings, or Fabry-Perot Etalons. J. Opt. Soc. Am. 1954, 44 (10), 761-765.
(18) Knorr, F. J.; Eatherton, R. L.; Siems, W. F.; Hill, H. H., Jr. Fourier Transform Ion Mobility Spectrometry. Anal. Chem. 1985, 57 (2), 402-406.
(19) Kwantwi-Barima, P.; Reinecke, T.; Clowers, B. H. Increased Ion Throughput Using Tristate Ion-Gate Multiplexing. Analyst 2019, 144 (22), 6660-6670.
(20) Cabrera, E. R.; Clowers, B. H. Synchronized Stepped Frequency Modulation for Multiplexed Ion Mobility Measurements. J. Am. Soc. Mass Spectrom. 2022, 33 (3), 557-564.
(21) Shannon, C. E. Communication in the Presence of Noise. Proc. IRE 1949, 37(1), 10-21.
(22) Blackman, R. B.; Tukey, J. W. The Measurement of Power Spectra from the Point of View of Communications Engineering—Part I. Bell Syst. Tech. J. 1958, 37 (1), 185-282.
(23) Donald P. Orofino, P. C. P. Multirate Digital Signal Processing Algorithm to Calculate Complex. J. Account. Soc. Am. 1992, 92 (1), 563-582.
(24) Miao, G. J. Sampling Theory. In Signal Processing in Digital Communications; Artech House, 2007; pp 91-108.
(25) Reinecke, T.; Clowers, B. H. Implementation of a Flexible, Open-Source Platform for Ion Mobility Spectrometry. HardwareX 2018, 4, e00030.
(26) Garcia, L.; Saba, C.; Manocchio, G.; Anderson, G. A.; Davis, E.; Clowers, B. H. An Open Source Ion Gate Pulser for Ion Mobility Spectrometry. Int. J. Ion Mobil. Spectrom. 2017, 20 (3), 87-93.
(27) Langejuergen, J.; Allers, M.; Oermann, J.; Kirk, A.; Zimmermann, S. High Kinetic Energy Ion Mobility Spectrometer: Quantitative Analysis of Gas Mixtures with Ion Mobility Spectrometry. Anal. Chem. 2014, 86 (14), 7023-7032.
(28) Cabrera, E. R.; Clowers, B. H. Synchronized Stepped Frequency Modulation for Multiplexed Ion Mobility Measurements. J. Am. Soc. Mass Spectrom. https://doi.org/10.1021/jasms.1c00365.
(29) Chambers, M. C.; Maclean, B.; Burke, R.; Amodei, D.; Ruderman, D. L.; Neumann, S.; Gatto, L.; Fischer, B.; Pratt, B.; Egertson, J.; Hoff, K.; Kessner, D.; Tasman, N.; Shulman, N.; Frewen, B.; Baker, T. A.; Brusniak, M.-Y.; Paulse, C.; Creasy, D.; Flashner, L.; Kani, K.; Moulding, C.; Seymour, S. L.; Nuwaysir, L. M.; Lefebvre, B.; Kuhlmann, F.; Roark, J.; Rainer, P.; Detlev, S.; Hemenway, T.; Huhmer, A.; Langridge, J.; Connolly, B.; Chadick, T.; Holly, K.; Eckels, J.; Deutsch, E. W.; Moritz, R. L.; Katz, J. E.; Agus, D. B.; MacCoss, M.; Tabb, D. L.; Mallick, P. A Cross-Platform Toolkit for Mass Spectrometry and Proteomics. Nat. Biotechnol. 2012, 30 (10), 918-920.
(30) Reinecke, T.; Davis, A. L.; Clowers, B. H. Determination of Gas-Phase Ion Mobility Coefficients Using Voltage Sweep Multiplexing. J. Am. Soc. Mass Spectrom. 2019, 30 (6), 977-986.
(31) Naylor, C. N.; Reinecke, T.; Clowers, B. H. Assessing the Impact of Drift Gas Polarizability in Polyatomic Ion Mobility Experiments. Anal. Chem. 2020, 92 (6), 4226-4234.
(32) Demoranville, L. T.; Houssiau, L.; Gillen, G. Behavior and Evaluation of Tetraalkylammonium Bromides as Instrument Test Materials in Thermal Desorption Ion Mobility Spectrometers. Anal. Chem. 2013, 85 (5), 2652-2658.
(33) Picache, J. A.; Rose, B. S.; Balinski, A.; Leaptrot, K. L.; Sherrod, S. D.; May, J. C.; McLean, J. A. Collision Cross Section Compendium to Annotate and Predict Multi-Omic Compound Identities. Chem. Sci. 2019, 10 (4), 983-993.
(34) Zheng, X.; Aly, N. A.; Zhou, Y.; Dupuis, K. T.; Bilbao, A.; Paurus, V. L.; Orton, D. J.; Wilson, R.; Payne, S. H.; Smith, R. D.; Baker, E. S. A Structural Examination and Collision Cross Section Database for over 500 Metabolites and Xenobiotics Using Drift Tube Ion Mobility Spectrometry. Chem. Sci. 2017, 8 (11), 7724-7736.
(35) McLean, J. A. The Mass-Mobility Correlation Redux: The Conformational Landscape of Anhydrous Biomolecules. J. Am. Soc. Mass Spectrom. 2009, 20 (10), 1775-1781.

### Example 4

### Synchronized Stepped Frequency Modulation for Multiplexed Ion Mobility Measurements

Implementation of frequency encoded multiplexing for ion mobility spectrometry (e.g., Fourier Transform Ion Mobility Spectrometry, (FT-IMS)) has facilitated the direct coupling of drift tube ion mobility instrumentation with ion trap mass analyzers despite their duty cycle mismatch. Traditionally, FT-IMS experiments have been carried out utilizing continuous linear frequency sweeps that are independent of the scan rate of the ion trap mass analyzer; thus, creating a situation where multiple frequencies are swept over two sequential mass scans. This in turn creates a degree of ambiguity in which the ion current derived from a single modulation frequency cannot be assigned to a single datapoint in the frequency modulated signal. In an effort to eliminate this ambiguity, this work describes a discrete stepwise function to modulate the ion gates of the IMS while synchronization between the generated frequencies and the scan rate of the linear ion trap is achieved. While the number of individual frequencies used in the stepped frequency sweeps is less than in continuous linear modulation experiments, there is no loss in performance and maintain high levels of precision across differing combinations of terminal frequencies and scan lengths. Furthermore, the frequency-scan synchronization enables further data processing techniques such as linear averaging of the frequency modulated signal to drastically improve signal-to-noise ratio for both high and low intensity analytes.

### INTRODUCTION

Adding a method of separation such as ion mobility to mass spectrometry allows for identification of isobaric compounds such as enantiomers or structural isomers that contain features not seen in the mass domain.1-4 While there are benefits to this combination of instrumentation, there are challenges to be overcome such as the duty cycle mismatch between both instruments. Typically, signal averaged drift tube ion mobility spectrometry experiments (DT-IMS) allow admission of one packet of ions into the drift region at a time. Separation of ions within the packet is based on differences in velocity under a weak electric field and a counterflow of a neutral drift gas; a metric known as its mobility coefficient. This process is repeated many times and occurs at an interval in the order of tens of milliseconds. In contrast, mass spectrometers such as linear ion traps have an acquisition rate in the order of one mass scan per hundreds of milliseconds; a rate too slow for nested mass information within the arrival time distribution. This challenge has been overcome by implementation of Fourier or Hadamard-based multiplexing methods to this hyphenated technique (IMS-MS). 5-8 Compared to the <1% duty cycle of signal averaged IMS experiments, Fourier based multiplexed IMS experiments reach upwards of 25% duty cycle and drastically decreases the amount of sample loss from continuous ionization sources such as the commonly used electrospray ionization.9 In addition to duty cycle improvements, there are inherent throughput and signal-to-noise (SNR) ratio improvements in multiplexed experiments attributed to both the Fellgett and Jacquinot advantages, respectively.10-12 In order to mitigate ion losses and realize better ion utilization, approaches such as ion accumulation through the use of ion traps,13 ion funnels,9 PASEF,14 TWAVE, 15 and SLIM onboard accumulation16 have been implemented. The caveat to these approaches is they require radially confining RF fields and lower pressures (i.e., <10 Torr) to function. In contrast, multiplexing approaches can be implemented using DT-IMS operating at atmospheric pressure which simplifies implementation.

Fourier based multiplexing experiments (FT-IMS) involve the simultaneous opening and closing of two ion gates at each end of the IMS drift region. The modulation of these gates is accomplished by using a predefined frequency sweep typically starting at a low but non-zero frequency (e.g., 5 Hz) and ending at a desired terminal frequency (e.g., 8005 Hz).8 For a given frequency, only ions with specific mobilities are able to traverse the drift region and continue past the second gate while it is still in the open state. Following the second gate, ions arrive at the vacuum interface of the mass spectrometer for subsequent mass analysis and detection. The sweeping of these frequencies and continuous generation of ions into the IMS generates an oscillating signal for all masses within the user-defined scanning range of the mass spectrometer. Fourier transform of this oscillating signal will generate a frequency domain representation which can then be directly converted into an arrival time distribution (ATD) by dividing the frequency (Hz) axis by the sweep rate (Hz/s).5

While Fourier-based multiplexing of ion mobility experiments has seen success,6,17-22 there are ambiguities that exist within the experiment, particularly the assignment of frequencies at a given time point within the frequency modulated signal. In short, the traditional method of performing FT-IMS experiments requires synchronizing only the start and end times of the frequency sweep and first and last scans of the mass spectrometer. When this approach is taken, frequencies are swept through in a continuous manner whereas mass scans are acquired in semi-repetitive fashion according to user-defined scan parameters (e.g., mass range). Though not immediately obvious to the casual user, the target scan rate in many commercial ion trap mass analyzers is not rigorously followed and often can vary by tens to hundreds of milliseconds owing to instrumental overhead (e.g., resetting of electronics and automatic gain control). Consequently, the continuous linear frequency sweeps in the traditional FT-IMS experiment and the semi-regular mass scans establish conditions where uncertainty emerges as to which ion gating frequency is contributing to the ion current observed in the mass spectrum. More specifically, this ambiguity arises when a recorded mass scan captures ion signal from more than one frequency (i.e., all the frequencies swept over since the previous mass scan). FT-IMS according to one or more embodiments ameliorates this issue by using a discrete stepped frequency sequence, with step intervals synchronized to the scan rate of the ion trap mass spectrometer. This approach removes any ambiguity of which mobilities are admitted into the mass spectrometer at a given data acquisition point. Using common metrics such as resolving power and signal-to-noise ratio, this work evaluates the performance of the stepped frequency sweeps across differing sweep parameters. Despite the stepped sequence having a lower number of different frequencies than the continuous linear sweeps, there are no losses in performance and high levels of precision are maintained. Furthermore, due to the unambiguous designation of frequencies at each data acquisition point, linear averaging of the frequency modulated signal becomes possible and therefore allows for drastic increases in signal-to-noise ratio in the arrival time distribution for both high and low intensity analytes.

### Experimental Methods

### Atmospheric Pressure Dual-Gate Drift Tube Ion Mobility Linear Ion Trap Mass Spectrometer

Ion mobility experiments were performed using an atmospheric pressure dual-gate PCB drift tube system operating under ambient conditions (˜690-700 Torr, ˜25° C.). The drift region of the IMS was 17.4 cm and bracketed by two sets of ion gates following the tri-grid shutter principles outlined by Reinecke et al. and Langejuergen et al. The ion gates were driven by a set of open-source ion gate pulsers described previously.23-25 Prior to the drift region, ions are desolvated in a 10 cm region containing the same electric field gradient as the drift cell. Voltages applied to the drift region were ˜490 V cm-1 for all experiments. The ion mobility spectrometer was coupled to a linear ion trap mass spectrometer (LTQ, Thermo Scientific, San Jose, CA). A counterflow of dry and purified nitrogen drift gas was introduced into the drift region at 2.5 L min-1 at the interface between the IMS and LTQ. It is worthy to note that the conductance of the inlet capillary is approximately 2 L min-1 leaving ˜500 mL min-1 as a counter current flow.

### Chemicals and Reagents

Analytes used to evaluate the performance of each of the sweeps included tetraalkylammonium salts (Sigma-Aldrich, St. Louis, MO), morphine (Cerrilant, Round Rock, TX), cocaine (Cerrilant, Round Rock, TX), and leucine-enkephalin (Sigma-Aldrich, St. Louis, MO). For experiments where continuous linear and stepped frequency sweeps are compared, a mixture of 500 nM tetrabutylammonium n (T4A), tetraoctylammonium (T8A), tetradodecylammonium (T12A), and 10 μM leucine enkephalin (leu-enk) were used. All subsequent experiments used a mixture of 2 μM morphine, 500 nM cocaine, 500 nM T8A, and 10 μM leu-enk. All solutions were made in 95:5 mixture of acetonitrile and water with 0.1% formic acid and electrosprayed into the desolvation region of the IMS. A custom glass capillary emitter with a nominal ID of 75 μm was held at +2500 V relative to the first electrode on the IMS.

### Frequency Sweep Generation and Data Analysis

Custom python scripts were developed to generate the frequency sweeps used to modulate the ion gates of the ion mobility spectrometer. All sweeps started at 5 Hz with terminal frequencies of 2505, 5005, 7505, and 8005 Hz. The lengths of these sweeps were 500, 1000, 1500, 2000 scans for the stepped frequency sweeps, which in turn determined the frequency step size throughout the duration of the experiment. Due to the lack of sweep-scan rate synchronization in the continuous linear sweep experiments, their duration was matched to the scan length duration of the stepped experiments to maintain an equivalent sweep rate. For reference, a 2000 scan experiment is generally ˜7 minutes and may vary depending on the mass range of interest. To generate the stepped sweeps, a 200 MHz Arduino-compatible microcontroller (Wio Terminal, Seeedstudio) running code developed in-house was used to modulate the ion beam within the drift cell. The changes in the frequency output by the waveform generator (Analog AD9850) were synchronized with the beginning of each mass scan of the linear ion trap using the TTL output from the LTQ. As detailed in the assembly instructions (see below), a voltage level shifter was used to accommodate the different signal levels from the LTQ and the 3.3 V logic levels used for the microcontroller. For comparison experiments, continuous linear frequency sweeps were generated using the previously referenced python script and streamed to the ion gates using IGOR Pro 8.0 (Wavemetrics, Lake Oswego, OR) and a NI-Multifunction DAQ data acquisition system (USB-6351, National Instruments, Austin, TX). For these latter experiments only the start of the waveform generation was synchronized with the ion trap using a contact closure mechanism. The relevant python scripts, firmware code, and bill of materials for the stepped frequency generator are included as part of the Supporting Information and at the following (https://github.com/bhclowers/Stepped-Pulser).

To process the respective ion modulation approaches datasets were converted from the LTQ “.RAW” file format into the “.mzML” file format using the “msConvertGui” tool from Proteo Wizard.26 Using Python scripts developed in-house, mass spectra and extracted ion chromatograms (frequency modulated signals) were generated. Each of the frequency modulated signals was extracted from a user defined mass window, in which for all cases, the mass window included the monoisotopic peak of interest and its associated isotopic peaks. The first step in processing the frequency modulated signal required making a new time axis vector of evenly spaced data points that closely matched the original. A spline object of the data was subsequently created and evaluated at the new time axis vector. Creating this spline with evenly spaced points was necessary due to small variations in time between scans across multiple replicates for the ion trap data acquisition cycle. It is important that this spline is created using the same number of points as the original dataset in order to maintain the original sampling frequency of the LTQ and to ensure the Nyquist frequency was not erroneously changed. The newly splined signal was then Fourier transformed where the magnitude of the signal was used. To recover the arrival time distribution, the frequency axis (Hz) obtained by the Fourier transform was divided by the sweep rate (Hz/s) and multiplied by 1000 to create an axis represented in milliseconds. Further details on code and python packages used to process the datasets can be found in the Supporting Information and on the previously referenced github repository.

### Results and Discussion

### Stepped and Continuous Linear Sweep Resolving Power Comparison

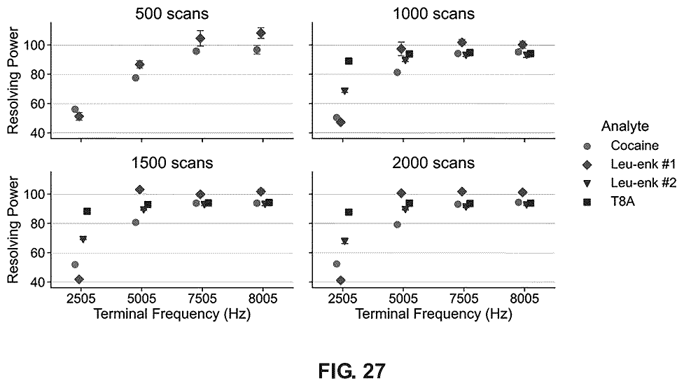

FIG. 27 shows resolving power comparison between continuous linear and stepped frequency experiments at 2000 scans for tetraalkylammonium salts, T4A, T8A, T12A, and leu-enk singly charged monomer. With highest resolving power values achieved at higher terminal frequencies, both methods show similar performance across all sweep parameters. Each bar value is an average of five replicates and error bars show standard deviation.

To ensure there was no loss in performance when implementing the stepped frequency sweeps, resolving power between both stepped and continuous linear methods were compared. For this comparison and all other resolving power calculations in this work, the definition of resolving power used was Rp=td/FWHM, where td is the drift time of the analyte and FWHM is the width of the peak at half its maximum intensity. Analytes for this comparison were the 1+ charge state monomer of leu-enk, T4A, T8A, and T12A. Sweep parameters for these comparisons were as follows: starting frequency for all experiments was 5 Hz with varying terminal frequencies of 2505, 5005, 7505, and 8005 Hz. Scan lengths were kept constant at 2000 scans for all stepped frequency experiments. As for the continuous linear sweep experiments, due to lack of scan-frequency synchronization, sweep time was chosen to match the length of the stepped sweeps to maintain an equivalent sweep rate (Hz/s) and therefore only start and end of experiments were matched.

Resolving power values and their standard deviations are shown in FIG. 27, with each resolving power value being the average of five replicates. Across all analytes used in this comparison, resolving power was similar for stepped and continuous sweeps across all terminal frequencies used, with the stepped sweeps showing a slight improvement across almost all comparisons. This result was expected and essential for deployment of a new waveform generator and modulation technique. For both sweep types, resolving power reaches values ˜80-90 at terminal frequencies as low as 5005 Hz. In general, as terminal frequency is increased, resolving power also increases, albeit with small gains after 5005 Hz. This trend is in agreement with previous FT-IMS experiments conducted by Morrison et al.6 Another important observation from this dataset is that the stepped frequency sweeps often displayed higher degrees of precision than results from the continuous sweeps. The most drastic improvements were seen at terminal frequencies of 2505 and 5005 Hz as shown in FIG. 27. We attribute this trend to the unambiguous nature of the frequency designation at each data point. This in turn yields ion signal resonant with a single frequency and therefore allowing for more uniformity in the frequency modulated signal across replicates.

### Resolving Power and SNR Evaluated Using Different Sweep Parameters

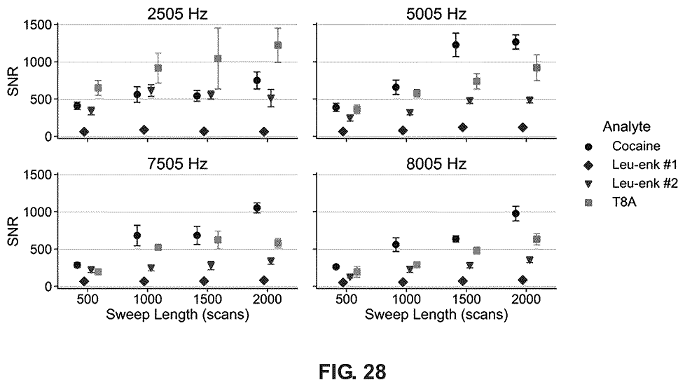

FIG. 28 shows resolving power measured for different combinations of sweep lengths and terminal frequencies for cocaine, T8A, leu-enk dimer (leu-enk #1), and leu-enk monomer (leu-enk #2). Across all sweep lengths, the highest resolving power values are achieved at higher terminal frequencies. Each point is an average of five replicates with error bars showing standard deviation.

To further evaluate the performance of the stepped frequency sweeps, resolving power and signal to noise ratio were measured at differing combinations of terminal frequencies and scan lengths to determine whether scan length or terminal frequency had a greater impact on both of these metrics. For these experiments, cocaine, T8A, and leu-enk were used. For the purposes of discussion surrounding the observed leucine enkephalin species, the doubly charged homodimer (i.e., [2M+2H]2+) and monomeric forms [M+H]+ correspond to the abbreviated peaks leu-enk #1 and leu-enk #2, respectively. It should be made clear that while extensive work on species identification for each peak in the leu-enk ATD was not performed, peak assignments were based on collisional cross section (CCS) calculations for the [M+H]+ monomer showing agreement with reported CCS values27 and relative mobility trends between monomers and doubly charged homodimers showing agreement with previous reports.28 Scan parameters used for these experiments were as follows: starting frequency for all experiments was 5 Hz, terminal frequencies at 2505, 5005, 7505, and 8005 Hz, and the sweeps carried out at scan lengths of 500, 1000, 1500, and 2000 scans.

FIG. 28 shows the resolving power for all sweep parameters tested. Across these parameters, the highest resolving power values are achieved at higher terminal frequencies; in agreement with the results shown in FIG. 27. This trend was maintained regardless of scan length. In some cases resolving power values exceed 100, such as for the leu-enk homodimer (leu-enk #1) at 1500 scans and a terminal frequency of 5005 Hz. However, resolving power across most scan-length experiments continues to show a plateauing at this frequency and slightly later at 7505 Hz for the 500 point datasets. This indicates that lower terminal frequencies in combination with shortened scan lengths will yield similar resolving power to experiments utilizing higher terminal frequencies and experimental times. It is important to note that for the 500 scan subplot in FIG. 28, leu-enk peak #2 and T8A were intentionally excluded. This was done due to the combination of sweep rate and Nyquist frequency at terminal frequencies greater than 7505 Hz limiting the maximum drift time in the arrival time distribution (ATD) that could be recorded (the relationship between drift times that can be captured with a given set of frequencies is described by the work by Knorr and Siems).5 This cutoff results in the Fourier transform of the signal to give incorrect frequencies from this aliased signal and therefore giving incorrect drift times for these particular analytes. Due to the direct relationship between resolving power and drift time, these were removed from FIG. 28 due to erroneous data and comparisons.

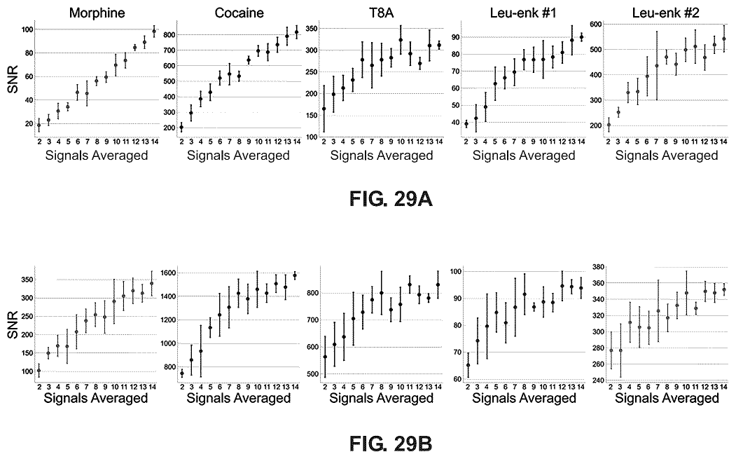

FIG. 29 shows signal to noise ratio (SNR) comparison for cocaine, T8A, leu-enk homodimer (leu-enk #1), and leu-enk monomer (leu-enk #2). SNR measured at differing combinations of terminal frequencies and scan lengths. Longer scans produce higher signal to noise ratio values at each terminal frequency used. Each point is an average of five replicates and error bars show standard deviation.

For all signal to noise ratio measurements, signal was the maximum of the peak of interest and a region of 10 ms (e.g., 10-20 ms) in the ATD with little to no ion signal was chosen for the noise region. Using this region, the average of the baseline intensity plus 3× its standard deviation was used as the noise value. FIG. 29 shows SNR values across the different sweep lengths and terminal frequencies used for cocaine, T8A, and both leu-enk homodimer (leu-enk #1) and monomer (leu-enk #2). Across all terminal frequencies used, the signal to noise ratio increases are seen as the number of scans per experiment is increased. SNR values for the leu-enk homodimer are much lower than all other analytes in the comparison due to low relative abundance relative to the monomer species. The high variability for T8A SNR values for 2505 Hz subplot in FIG. 28 is due to the chosen noise region interval. For consistency the same noise region in their respective ATD was used for all analytes. For this particular region, the T8A showed the highest variation in baseline intensity and higher levels of precision could be attained if a more appropriate region was chosen. However, although variability was higher for T8A, it showed high SNR values and followed the same SNR trends as all other analytes, where values increase with longer scan lengths.

This dependence of SNR on scan length as shown in FIG. 29 is attributed to the increased number of points across the span of the frequency modulated signal for a given terminal frequency; allowing for a more complete representation across oscillations and thus capturing maximum ion current where full frequency resonance occurs. This allows for a cleaner and more uniform frequency modulated signal and reduced noise levels post-Fourier transform. Furthermore, another contributing factor is the raw number of bins that allow for noise to spread out into and therefore increasing the benefit from the multiplex advantage.

SNR Improvements from Signal Averaging

Referring to FIG. 29 signal to noise ratio (SNR) comparison for the linear averages include subplot (a) for 500 scan and subplot (b) 1000 scan-length frequency modulated signals for morphine, cocaine, T8A, and both leu-enk monomer and dimer, each column labeled accordingly. Each point is the average of 5 replicates and error bars show standard deviation. Significant signal to noise ratio increases are seen for all analytes as the number of averages increases.

The unambiguous designation of frequencies at each data point allows for the assumption that the ion signal gathered at each point is from ion-current resonant with a single frequency. As a consequence, frequency modulated signals across multiple replicates are highly uniform, examples of which are shown in the left column of FIG. 5. However, even though high signal to noise ratios are achieved at the acquisition level, they are not identical. Fluctuations in experimental conditions such as pressure, temperature, or instrumental noise contribute to variation between replicates, and therefore higher quality arrival time distributions can be reconstructed by linear averaging of the frequency modulated signal pre-Fourier transform.

Spectra derived from continuous frequency sweep FT-IMS experiments are often the result of a single frequency sweep. As noted previously, the slight variations in instrumental overhead for commercial ion trap mass analyzers make direct signal averaging under such conditions difficult. Alternatively, the stepped frequency approach provides a foundation to directly average separate experiments. For the signal averaging experiments using the synchronized frequency sweeps, data handling involved random sampling from a population of 16 intraday datasets acquired to minimize experimental conditions. For each number of averages, random sampling (without replacement) of the datasets was repeated five times, effectively creating five different replicates. Scripts performing the random sampling of the datasets included code to prevent any duplicate sets from being considered. It is worth noting that averaging was done after mass extraction of the frequency modulated signal for individual analytes. The compressed time span over which data were acquired was necessary to minimize the impact of environmental fluctuations on the observed signal to noise ratio. It is recognized that the observed measurement uncertainty may be biased through this exercise of random resembling of the technical replicates, but does provide a reasonable approach to evaluate the trends with signal to noise ratio.

FIG. 29 shows the signal to noise ratio trends for all analytes in a mixture of morphine, cocaine, T8A, and both the singly charged monomer and doubly charged dimer of leu-enk. Implementation of signal averaging yielded large signal to noise ratio improvements and continued to increase as the number of averaged signals was also increased. To be clear, due to the lack of exactly periodic cycling of the ion trap, prior efforts at averaging using the continuous sweep conditions and FT-IMS introduce a level of noise that degrades the expected SNR gains. The sweep conditions used for the stepped frequency experiments shown in FIG. 29 were 500 and 1000 scans using stepped frequency sweeps starting at 5 Hz with a terminal frequency of 7505 Hz. It is worth noting that morphine was the lowest intensity analyte peak and about 1/7th of the intensity of the tallest peak in the mass spectrum. It had the most significant improvements in signal-to-noise ratio, showing ˜5× improvement in the 500 scan sweeps. Examples of the averaged signals for morphine and the resulting Fourier transform can be seen in FIG. 5 center and right columns, respectively.

An important consideration for conducting signal averaging of stepped FT-IMS experiments is that averaged signals should be recorded within a reasonable amount of time from each other. As mentioned previously, analyte drift times will vary depending on fluctuations in experimental conditions and, as a consequence, drift times will have differing resonant frequencies and cause shifting in the oscillations within the frequency modulated signal. These shifts will cause broadening when averaged and therefore degrade the quality of the reconstructed arrival time distribution. A trade-off that must be considered for these experiments is whether a longer sweep with a low number of averages or shorter sweeps with a greater degree of averaging is desired.

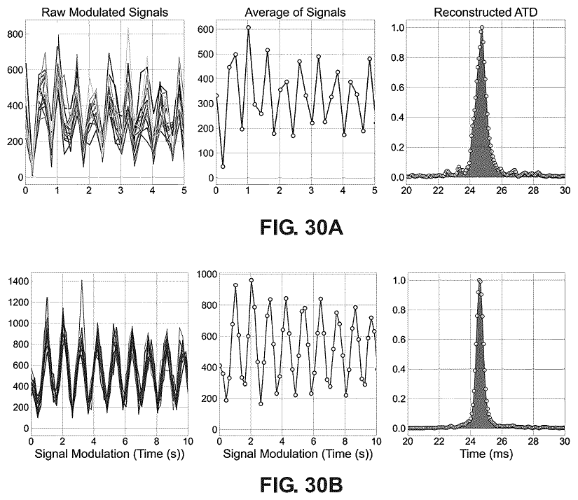

FIG. 30 shows interpolated frequency modulated signals for morphine shown in the left column taken over FIG. 30 subplot (a) 500 and subplot (b) 1000 scans and plotted up to the first 5 and 10 seconds, respectively, to show detail in the aligned oscillating signal. Linear averages of these signals are shown in the center column and their Fourier transform shown on the right column. Importantly, as the sample rate diminishes, a larger degree of ambiguity arises when converting the data to an ATD that distorts peak shape. A balance is required between the total experimental time and terminal sweep frequency in order to preserve the capacity to signal averaging the data.

The left column in FIG. 30 shows 16 frequency modulated signals overlaid on top of each other. In order to show detail of the signal oscillations, the signal was only plotted to the first 5 and 10 seconds for 500 and 1000 scan datasets, respectively. Time intervals shown for the frequency modulated signals were chosen to show a direct comparison in the same number of oscillations but at differing number of points between each; 5 seconds at 500 scans and 10 seconds at 1000 scans with the same terminal frequencies will produce the same number of oscillations in the signal due to the relationship between their effective sweep rates. The main differentiating factor here is the point density across the signal for 1000 scans is two times higher than for 500 scans across the same time interval and therefore producing more uniform peaks. Linear averaging of the signals in the left column of FIG. 30 produces the signal shown in the center column. Fourier transform of this averaged signal produces the arrival time distribution shown in the right column. Even with the direct synchronization with the LTQ, the data sets from experiments with a reduced number of experimental points (FIG. 30, Top Row) illustrate that an adequate number of frequency steps must be included to fully capture the oscillations in the frequency domain. Failure to adequately account for this behavior can induce aliasing and spectral broadening in the ATD due to the poorly resolved maxima and minima in the recorded signal.

### Experiment 4—Conclusion

Supplanting continuous linear sweeps with discrete stepped frequency waveforms does not adversely impact the resolving power, signal to noise ratio, or precision of ion mobility measurements made in combination with an ion trap mass analyzer. Furthermore, the unambiguous designation of frequencies in the frequency modulated signal generated by the stepped sweep approach allows for greater confidence in peak assignment in the frequency domain and, by extension, confidence in drift times in the reconstructed arrival time distribution. By minimizing any ambiguity in the modulation frequency delivering ion current to the mass analyzer, additional signal processing techniques are possible. Due to small fluctuations in ion trap acquisition rate, the use of the continuous linear frequency sweeps largely precluded traditional approaches to signal averaging. The synchronized, stepped frequency waveforms, on the other hand, is compatible with direct signal averaging between runs which drastically increases the signal to noise ratio for both high and low-intensity analytes. However, trade-offs between number of averaged signals and length of experiment must be taken into consideration in order to maintain near identical experimental conditions (e.g., temperature and pressure) as to not lose precision in the frequency modulated signal's oscillations. Through use of open-source code and easily attainable hardware for both building the PCB DT-IMS29 and frequency generation, the presented solution proves to be a low cost, highly flexible approach to implementing FT-IMS experiments. The concept of efficiently coupling drift tube IMS systems with ion trap mass analyzers is a relatively new development within the field with noticeable improvements in speed and resolution. To realize the ultimate potential of multiplexing in ion mobility for experiments employing ion trap mass analyzers, this report represents a critical, foundational step towards data-driven and customized modulation waveforms which find extensive utility in other analytical chemistry techniques including NMR and FT-ICR.30-33.

### Experiment 4—References

(1) Morrison, K. A.; Bendiak, B. K.; Clowers, B. H. Enhanced Mixture Separations of Metal Adducted Tetrasaccharides Using Frequency Encoded Ion Mobility Separations and Tandem Mass Spectrometry. J. Am. Soc. Mass Spectrom. 2017, 28 (4), 664-677.
(2) Zheng, X.; Aly, N. A.; Zhou, Y.; Dupuis, K. T.; Bilbao, A.; Paurus, V. L.; Orton, D. J.; Wilson, R.; Payne, S. H.; Smith, R. D.; Baker, E. S. A Structural Examination and Collision Cross Section Database for over 500 Metabolites and Xenobiotics Using Drift Tube Ion Mobility Spectrometry. Chem. Sci. 2017, 8 (11), 7724-7736.
(3) Theisen, A.; Black, R.; Corinti, D.; Brown, J. M.; Bellina, B.; Barran, P. E. Initial Protein Unfolding Events in Ubiquitin, Cytochrome c and Myoglobin Are Revealed with the Use of 213 Nm UVPD Coupled to IM-MS. J. Am. Soc. Mass Spectrom. 2019, 30 (1), 24-33.
(4) Dodds, J. N.; Baker, E. S. Ion Mobility Spectrometry: Fundamental Concepts, Instrumentation, Applications, and the Road Ahead. J. Am. Soc. Mass Spectrom. 2019, 30 (11), 2185-2195.
(5) Knorr, F. J.; Eatherton, R. L.; Siems, W. F.; Hill, H. H., Jr. Fourier Transform Ion Mobility Spectrometry. Anal. Chem. 1985, 57 (2), 402-406.
(6) Morrison, K. A.; Siems, W. F.; Clowers, B. H. Augmenting Ion Trap Mass Spectrometers Using a Frequency Modulated Drift Tube Ion Mobility Spectrometer. Anal. Chem. 2016, 88 (6), 3121-3129.
(7) Clowers, B. H.; Siems, W. F.; Hill, H. H.; Massick, S. M. Hadamard Transform Ion Mobility Spectrometry. Anal. Chem. 2006, 78 (1), 44-51.
(8) Reinecke, T.; Naylor, C. N.; Clowers, B. H. Ion Multiplexing: Maximizing Throughput and Signal to Noise Ratio for Ion Mobility Spectrometry. Trends Analyt. Chem. 2019, 116, 340-345.
(9) Clowers, B. H.; Ibrahim, Y. M.; Prior, D. C.; Danielson, W. F., 3rd; Belov, M. E.; Smith, R. D. Enhanced Ion Utilization Efficiency Using an Electrodynamic Ion Funnel Trap as an Injection Mechanism for Ion Mobility Spectrometry. Anal. Chem. 2008, 80 (3), 612-623.
(10) Fellgett, P. CONCLUSIONS ON MULTIPLEX METHODS. J. phys., Colloq. 1967, 28 (C2), C2-C165-C2-C171.
(11) Brock, A.; Rodriguez, N.; Zare, R. N. Hadamard Transform Time-of-Flight Mass Spectrometry. Anal. Chem. 1998, 70 (18), 3735-3741.
(12) Jacquinot, P. The Luminosity of Spectrometers with Prisms, Gratings, or Fabry-Perot Etalons. J. Opt. Soc. Am., JOSA 1954, 44 (10), 761-765.
(13) Hoaglund-Hyzer, C. S.; Lee, Y. J.; Counterman, A. E.; Clemmer, D. E. Coupling Ion Mobility Separations, Collisional Activation Techniques, and Multiple Stages of MS for Analysis of Complex Peptide Mixtures. Anal. Chem. 2002, 74 (5), 992-1006.
(14) Meier, F.; Brunner, A.-D.; Koch, S.; Koch, H.; Lubeck, M.; Krause, M.; Goedecke, N.; Decker, J.; Kosinski, T.; Park, M. A.; Bache, N.; Hoerning, O.; Cox, J.; Räther, O.; Mann, M. Online Parallel Accumulation-Serial Fragmentation (PASEF) with a Novel Trapped Ion Mobility Mass Spectrometer *. Mol. Cell. Proteomics 2018, 17 (12), 2534-2545.
(15) Giles, K.; Pringle, S. D.; Worthington, K. R.; Little, D.; Wildgoose, J. L.; Bateman, R. H. Applications of a Travelling Wave-Based Radio-Frequency-Only Stacked Ring Ion Guide. Rapid Commun. Mass Spectrom. 2004, 18 (20), 2401-2414.
(16) Deng, L.; Ibrahim, Y. M.; Baker, E. S.; Aly, N. A.; Hamid, A. M.; Zhang, X.; Zheng, X.; Garimella, S. V. B.; Webb, I. K.; Prost, S. A.; Sandoval, J. A.; Norheim, R. V.; Anderson, G. A.; Tolmachev, A. V.; Smith, R. D. Ion Mobility Separations of Isomers Based upon Long Path Length Structures for Lossless Ion Manipulations Combined with Mass Spectrometry. ChemistrySelect 2016, 1 (10), 2396-2399.
(17) Davis, A. L.; Reinecke, T.; Morrison, K. A.; Clowers, B. H. Optimized Reconstruction Techniques for Multiplexed Dual-Gate Ion Mobility Mass Spectrometry Experiments. Anal. Chem. 2019, 91 (2), 1432-1440.
(18) Sanders, J. D.; Butalewicz, J. P.; Clowers, B. H.; Brodbelt, J. S. Absorption Mode Fourier Transform Ion Mobility Mass Spectrometry Multiplexing Combined with Half-Window Apodization Windows Improves Resolution and Shortens Acquisition Times. Anal. Chem. 2021, 93 (27), 9513-9520.
(19) Kwantwi-Barima, P.; Reinecke, T.; Clowers, B. H. Increased Ion Throughput Using Tristate Ion-Gate Multiplexing. Analyst 2019, 144 (22), 6660-6670.
(20) McKenna, K. R.; Clowers, B. H.; Krishnamurthy, R.; Liotta, C. L.; Fernández, F. M. Separations of Carbohydrates with Noncovalent Shift Reagents by Frequency-Modulated Ion Mobility-Orbitrap Mass Spectrometry. J. Am. Soc. Mass Spectrom. 2021. doi.org/10.1021/jasms.1c00184.
(21) McCabe, J. W.; Shirzadeh, M.; Walker, T. E.; Lin, C.-W.; Jones, B. J.; Wysocki, V. H.; Barondeau, D. P.; Clemmer, D. E.; Laganowsky, A.; Russell, D. H. Variable-Temperature Electrospray Ionization for Temperature-Dependent Folding/Refolding Reactions of Proteins and Ligand Binding. Anal. Chem. 2021, 93 (18), 6924-6931.
(22) Poltash, M. L.; McCabe, J. W.; Shirzadeh, M.; Laganowsky, A.; Clowers, B. H.; Russell, D. H. Fourier Transform-Ion Mobility-Orbitrap Mass Spectrometer: A Next-Generation Instrument for Native Mass Spectrometry. Anal. Chem. 2018, 90 (17), 10472-10478.
(23) Reinecke, T.; Davis, A. L.; Clowers, B. H. Determination of Gas-Phase Ion Mobility Coefficients Using Voltage Sweep Multiplexing. J. Am. Soc. Mass Spectrom. 2019, 30 (6), 977-986.
(24) Langejuergen, J.; Allers, M.; Oermann, J.; Kirk, A.; Zimmermann, S. High Kinetic Energy Ion Mobility Spectrometer: Quantitative Analysis of Gas Mixtures with Ion Mobility Spectrometry. Anal. Chem. 2014, 86 (14), 7023-7032.
(25) Garcia, L.; Saba, C.; Manocchio, G.; Anderson, G. A.; Davis, E.; Clowers, B. H. An Open Source Ion Gate Pulser for Ion Mobility Spectrometry. Int. J. Ion Mobil. Spectrom. 2017, 20 (3), 87-93.
(26) Chambers, M. C.; Maclean, B.; Burke, R.; Amodei, D.; Ruderman, D. L.; Neumann, S.; Gatto, L.; Fischer, B.; Pratt, B.; Egertson, J.; Hoff, K.; Kessner, D.; Tasman, N.; Shulman, N.; Frewen, B.; Baker, T. A.; Brusniak, M.-Y.; Paulse, C.; Creasy, D.; Flashner, L.; Kani, K.; Moulding, C.; Seymour, S. L.; Nuwaysir, L. M.; Lefebvre, B.; Kuhlmann, F.; Roark, J.; Rainer, P.; Detlev, S.; Hemenway, T.; Huhmer, A.; Langridge, J.; Connolly, B.; Chadick, T.; Holly, K.; Eckels, J.; Deutsch, E. W.; Moritz, R. L.; Katz, J. E.; Agus, D. B.; MacCoss, M.; Tabb, D. L.; Mallick, P. A Cross-Platform Toolkit for Mass Spectrometry and Proteomics. Nat. Biotechnol. 2012, 30 (10), 918-920.
(27) Nichols, C. M.; May, J. C.; Sherrod, S. D.; McLean, J. A. Automated Flow Injection Method for the High Precision Determination of Drift Tube Ion Mobility Collision Cross Sections. Analyst 2018, 143 (7), 1556-1559.
(28) Morrison, K. A.; Bendiak, B. K.; Clowers, B. H. Assessment of Dimeric Metal-Glycan Adducts via Isotopic Labeling and Ion Mobility-Mass Spectrometry. J. Am. Soc. Mass Spectrom. 2018, 29 (8), 1638-1649.
(29) Reinecke, T.; Clowers, B. H. Implementation of a Flexible, Open-Source Platform for Ion Mobility Spectrometry. HardwareX 2018, 4, e00030.
(30) Kupče, E.; Freeman, R. Fast Multi-Dimensional Hadamard Spectroscopy. J. Magn. Reson. 2003, 163 (1), 56-63.
(31) Blechta, V.; Freeman, R. Multi-Site Hadamard NMR Spectroscopy. Chem. Phys. Lett. 1993, 215 (4), 341-346.
(32) Ross, C. W.; Guan, S.; Grosshans, P. B.; Ricca, T. L.; Marshall, A. G. Two-Dimensional Fourier Transform Ion Cyclotron Resonance Mass Spectrometry/mass Spectrometry with Stored-Waveform Ion Radius Modulation. J. Am. Chem. Soc. 1993, 115 (17), 7854-7861.
(33) Marshall, A. G.; Chen, T. 40 Years of Fourier Transform Ion Cyclotron Resonance Mass Spectrometry. Int. J. Mass Spectrom. 2015, 377, 410-420.

We claim:

1. A method for multidimensional detecting of properties of particles, comprising:
measuring by a first measuring device a first property of particles, the measuring producing measurement values in a first domain, and the measuring including the first measuring device outputting the particles with a sequence stepped second domain modulation that corresponds to the particles' respective first domain measurement values,
wherein:
the sequence steps have a step interval extending in the first domain from a step start to a step stop, and have a second domain modulating state that changes from step to step according to a first domain to second domain modulating state trajectory, and
for each sequence step having a preceding step, the second domain modulation state of the preceding step differs from the second domain modulation state of said sequence step; and
performing, by a second measuring device steps comprising:
decoding of the particles' respective first domain measurement values by a demodulation of the sequence stepped second domain modulation, and
measuring a second property of the particles, over a measuring interval extending in the first domain from a measuring interval start point to a measuring interval end point, wherein:
the measuring interval start point and the measuring interval end point are synchronized to the step start and to the step stop.

2. The method of claim 1 for multidimensional detecting of properties of particles, wherein the sequence stepped second domain modulation is a stepped frequency modulation.

3. The method of claim 2 for multidimensional detecting of properties of particles, wherein for each step in the stepped sequence having a preceding step, a modulation frequency of the preceding step is lower or higher than a modulation frequency of said step.

4. The method of claim 2 for multidimensional detecting of properties of particles, wherein for each sequence step the modulation frequency is constant over the step interval.

5. The method of claim 2 for multidimensional detecting of properties of particles, wherein the respective step frequencies from step to step comprise a random sequence.

6. The method of claim 2 for multidimensional detecting of properties of particles, wherein the first domain to second domain modulating state trajectory is non-linear.

7. The method of claim 1 for multidimensional detecting of properties of particles, wherein the particles are ions.

8. The method of claim 7 for multidimensional detecting of properties of particles, wherein the first measuring device comprises an ion mobility spectrometer.

9. The method of claim 8 for multidimensional detecting of properties of particles, wherein the second measuring device comprises a mass spectrometer.

10. The method of claim 1 for multidimensional detecting of properties of particles, wherein the particles are molecules.

11. The method of claim 1 for multidimensional detecting of properties of particles, wherein the first measuring device comprises an ion mobility spectrometer and the second measuring device comprises a mass spectrometer.
